(19) United States
(12) Patent Application Publication
(10) Pub. No.: US 2025/0296528 A1
(43) Pub. Date: Sep. 25, 2025

(54) INFORMATION PROCESSING APPARATUS, INFORMATION PROCESSING METHOD, VEHICLE CONTROL APPARATUS, AND INFORMATION PROCESSING TERMINAL

(71) Applicant: Sony Group Corporation, Tokyo (JP)

(72) Inventors: Masatoshi FUJINO, Tokyo (JP); Yasuharu SEKI, Tokyo (JP)

(73) Assignee: Sony Group Corporation, Tokyo (JP)

(21) Appl. No.: 18/862,988

(22) PCT Filed: Apr. 28, 2023
(86) PCT No.: PCT/JP2023/016803

§ 371 Date: Nov. 5, 2024

(30) Foreign Application Priority Data
May 13, 2022 (JP) 2022-079196

(51) Int. Cl. B60R 25/24; B60R 25/01

(52) U.S. Cl. CPC B60R 25/24; B60R 25/01; B60R 2325/101; B60R 2325/103

(57) ABSTRACT

An information processing apparatus includes circuitry configured to create a digital key for using a vehicle, and set a usage rule for the digital key. The usage rule represents permitted usage of the vehicle. A transmitter transmits the digital key to at least one of the vehicle and/or an information processing terminal that uses the digital key, and transmits usage rule information representing the usage rule to at least one of the vehicle and/or the information processing terminal.

### CROSS REFERENCE TO RELATED APPLICATIONS

This application claims the benefit of Japanese Priority Patent Application JP 2022-079196 filed May 13, 2022, the entire contents of which are incorporated herein by reference.

### TECHNICAL FIELD

The present technology relates to an information processing apparatus, an information processing method, a vehicle control apparatus, and an information processing terminal, and, in particular, relates to an information processing apparatus, an information processing method, a vehicle control apparatus, and an information processing terminal that allow easy and flexible settings of permitted usage of a vehicle.

### BACKGROUND ART

According to a proposal in the past, in a case that key information regarding a vehicle on which a content providing apparatus is mounted is distributed to a mobile terminal of a user, function restriction information is added to the key information such that the user is permitted to lock and unlock the vehicle, and use the content providing apparatus, but is not permitted to travel with the vehicle (see PTL 1, for example).

### Citation list

### Patent Literature

PTL 1: Japanese Patent Laid-open No. 2019-104324

### SUMMARY OF INVENTION

### Technical Problem

However, with the present technology described in PTL 1, travelling of a vehicle is entirely restricted, and, therefore, the convenience lowers.

The present technology has been made in view of such a situation and aims to allow easy and flexible settings of permitted usage of a vehicle.

### Solution to Problem

An information processing apparatus according to a first aspect of the present technology is an information processing apparatus including circuitry configured to create a digital key to operate a vehicle, and set a usage rule for the digital key, the usage rule including usage rule information that sets permitted conditions of usage of the vehicle; and a transmitter configured to transmit the digital key to at least one of the vehicle and/or an information processing terminal that uses the digital key, and transmit the usage rule information to at least one of the vehicle and/or the information processing terminal.

An information processing method according to the first aspect of the present technology is an information processing method performed by an information processing apparatus, the information processing method including creating a digital key to operate a vehicle, setting a usage rule for the digital key, the usage rule including usage rule information that sets permitted conditions of usage of the vehicle, transmitting the digital key to at least one of the vehicle and/or an information processing terminal that uses the digital key, and transmitting the usage rule information at least one of the vehicle and/or the information processing terminal.

A vehicle control apparatus according to a second aspect of the present technology is a vehicle control apparatus including circuitry configured to control permitted usage of a vehicle on a basis of a usage rule set for a digital key by an information processing apparatus that has created the digital key, and a receiver configured to receive the digital key transmitted from an information processing terminal.

An information processing terminal according to a third aspect of the present technology is an information processing terminal including a receiver configured to receive from an information processing apparatus a digital key for which a usage rule representing permitted usage of a vehicle is set, circuitry configured to retain the digital key, and a transmitter that transmits the digital key to the vehicle under a condition the information processing terminal has received an indication the vehicle is to be used.

In the first aspect of the present technology, a digital key for using a vehicle is created, a usage rule is set for the digital key, the usage rule representing permitted usage of the vehicle, and the digital key is transmitted to at least one of the vehicle and an information processing terminal that uses the digital key, and usage rule information representing the usage rule is transmitted to at least one of the vehicle and the information processing terminal.

In the second aspect of the present technology, permitted usage of a vehicle is controlled on a basis of a usage rule set for a digital key by an information processing apparatus that has created the digital key, the digital key being received from an information processing terminal.

In the third aspect of the present technology, a digital key for which a usage rule representing permitted usage of a vehicle is set is acquired from an information processing apparatus, and the digital key is transmitted to the vehicle in a case that the vehicle is to be used.

### BRIEF DESCRIPTION OF DRAWINGS

FIG. 1 is a block diagram depicting an embodiment of an information processing system to which the present technology is applied.

FIG. 2 is a figure depicting a configuration example of a cloud system and an example of an interface between a vehicle and mobile devices.

FIG. 3 is a block diagram depicting a configuration example of the cloud system.

FIG. 4 is a block diagram depicting a configuration example of a vehicle control system.

FIG. 5 is a block diagram depicting a configuration example of a mobile device.

FIG. 6 is a figure depicting an example of the types of users of the information processing system.

FIG. 7 is a figure depicting a relation among user accounts, roles, and usage rules.

FIG. 8 is a flowchart for explaining a shared-key creation process.

FIG. 9 is a figure depicting an example of a digital-key list screen.

FIG. 10 is a figure depicting an example of the digital-key list screen in a case that there are no digital keys.

FIG. 11 is a figure depicting an example of a digital-key reset screen.

FIG. 12 is a figure depicting an example of a key mode setting screen of the shared key.

FIG. 13 is a figure depicting an example of a shared-key validity period setting screen.

FIG. 14 is a figure depicting an example of a shared-key creation screen.

FIG. 15 is a figure depicting an example of a shared-key provision screen.

FIG. 16 is a sequence diagram for explaining a process of registering, in a vehicle, an unregistered pair key and a usage rule.

FIG. 17 is a sequence diagram for explaining a process of unlocking the door of a driver's seat.

FIG. 18 is a sequence diagram for explaining a process of unlocking a trunk.

FIG. 19 is a block diagram depicting a configuration example of a computer.

### DESCRIPTION OF EMBODIMENTS

Modes for carrying out the present technology are explained below. The explanation is given in the following order.
1. Embodiment
2. Modification Examples
3. Others

### 1. Embodiment

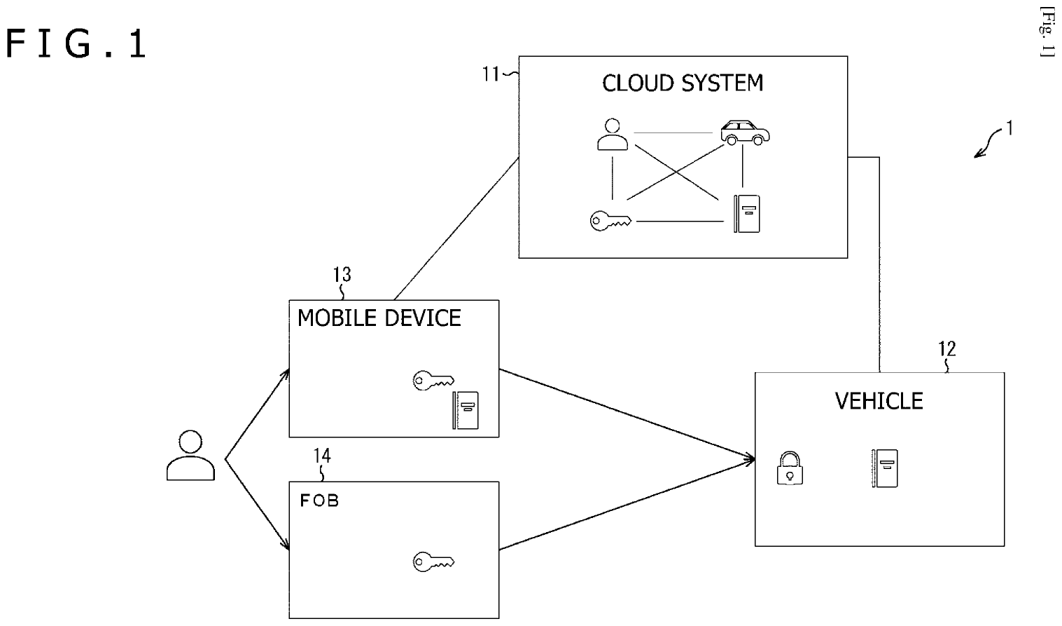

An embodiment of the present technology is explained with reference to FIG. 1 to FIG. 18.

### <Configuration Example of Information Processing System 1>

FIG. 1 depicts an embodiment of an information processing system 1 to which the present technology is applied.

The information processing system 1 is a system that performs management of a digital key for using a vehicle 12, and the like. FIG. 1 schematically depicts a configuration example of the information processing system 1.

The information processing system 1 includes a cloud system 11, the vehicle 12, a mobile device 13, and a FOB 14.

Note that, whereas each of the numbers of vehicles 12, mobile devices 13, and FOBs 14 depicted in the figures is one in order to simplify the explanation, actually, each of the numbers of the vehicles 12, the mobile devices 13, and the FOBs 14 to be provided is more than one.

In addition, vehicles 12 and mobile devices 13 do not necessarily have one-to-one relations, but it is also possible to provide a plurality of mobile devices 13 for one vehicle 12. That is, it is possible to allow usage of the one vehicle 12 by using each of the plurality of mobile devices 13. Similarly, vehicles 12 and FOBs 14 do not necessarily have one-to-one relations, but it is also possible to provide a plurality of FOBs 14 for one vehicle 12. That is, it is possible to allow usage of the one vehicle 12 by using each of the plurality of FOBs 14. In addition, conversely, it is possible to allow usage of each of a plurality of vehicles 12 by using one mobile device 13.

The cloud system 11 creates a digital key for using the vehicle 12, and a pair key that forms a pair with the digital key. For example, the pair key includes authentication information for authenticating the digital key at the vehicle 12. In addition, the cloud system 11 creates a usage rule (Usage Rule) representing permitted usage of the vehicle 12 by the digital key and sets a usage rule for the digital key and the pair key. The cloud system 11 manages a relation among the vehicle 12, a user (account), the digital key and the usage rule.

The cloud system 11 transmits, to the mobile device 13, the digital key, and information representing the usage rule (hereinafter, referred to as usage rule information). The cloud system 11 transmits the pair key and the usage rule information to the vehicle 12.

The vehicle 12 stores the pair key and usage rule information received from the cloud system 11 and manages a relation between the pair key and the usage rule. On the basis of the pair key, the vehicle 12 executes an authentication process of the digital key transmitted from the mobile device 13 or the FOB 14. In a case that the authentication of the digital key is successful, the vehicle 12 controls permitted usage of the vehicle 12 on the basis of the usage rule set for the digital key (the pair key corresponding to the digital key).

For example, the mobile device 13 includes an information processing terminal such as a smartphone that can be carried by the user. The mobile device 13 stores the digital key and usage rule information received from the cloud system 11 and manages a relation between the digital key and the usage rule. For example, the user transmits the digital key to the vehicle 12 by using the mobile device 13, and, in a case that authentication of the digital key is successful, can use the vehicle 12 in accordance with the permitted usage based on the usage rule set for the digital key.

The FOB 14 is a device dedicated for the vehicle 12 and retains the digital key in advance. For example, the user transmits the digital key to the vehicle 12 by using the FOB 14, and, in a case that authentication of the digital key is successful, can use the vehicle 12 without restrictions on the basis of the usage rule set for the digital key.

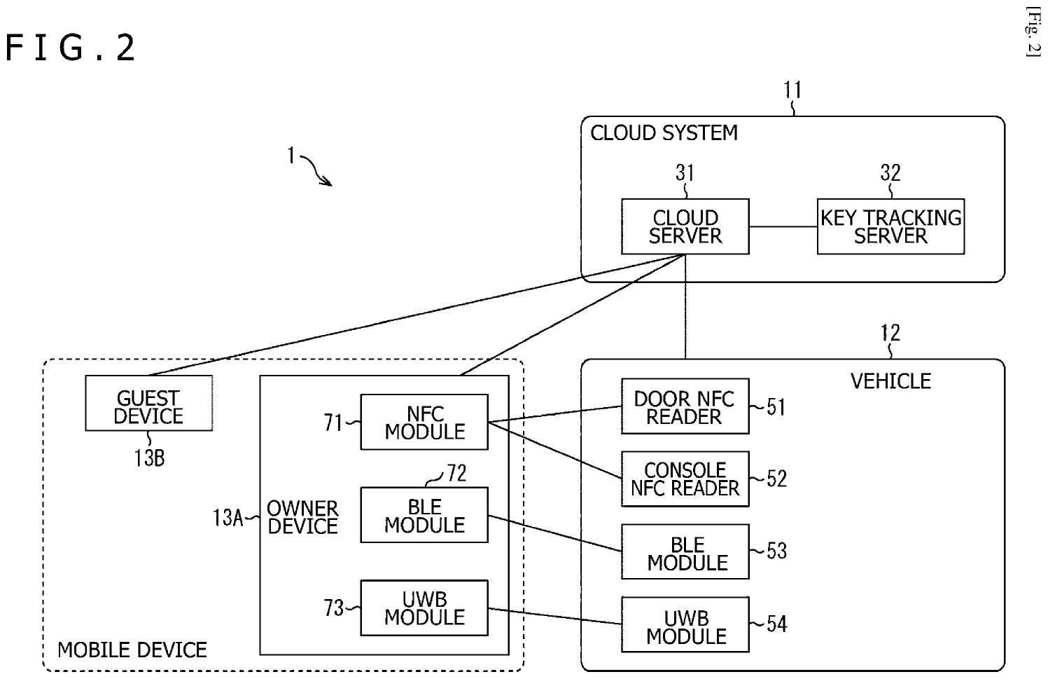

FIG. 2 depicts a configuration example of the information processing system 1 in more detail than FIG. 1. In particular, FIG. 2 depicts a configuration example of the cloud system 11, and a configuration example of an interface between the vehicle 12 and mobile devices 13.

For example, the mobile devices 13 are classified into an owner device 13A and a guest device 13B.

For example, the owner device 13A is a mobile device that is used by a user such as the owner of the vehicle 12 who uses the vehicle 12 daily or regularly, manages the vehicle 12, and so on.

For example, the guest device 13B is a mobile device that is used by a user who uses the vehicle 12 temporarily.

Note that the owner device 13A and the guest device 13B are simply referred to as a mobile device 13 below in a case that it is not necessary to make a distinction between them.

The cloud system 11 includes a cloud server 31 and a key tracking server 32.

The cloud server 31 is a server that manages information regarding the vehicle 12 and users. The cloud server 31 performs direct communication with the vehicle 12 and the mobile device 13.

The key tracking server 32 is a server that creates and manages digital keys, pair keys, and usage rules.

For example, the vehicle 12 includes a door NFC (Near Field Communication) reader 51, a console NFC reader 52, a BLE (Bluetooth Low Energy) module 53, and a UWB (Ultra-Wide Band) module 54.

For example, the door NFC reader 51 is provided to each door of the vehicle 12.

For example, the console NFC reader 52 is provided to a console in the interior of the vehicle 12.

For example, the mobile device 13 includes an NFC module 71, a BLE module 72, and a UWB module 73.

The NFC module 71 can communicate with the door NFC reader 51 and the console NFC reader 52.

For example, in a case that the mobile device 13 is brought close to a door of the vehicle 12 in order to unlock the door, the NFC module 71 communicates with the door NFC reader 51 provided near the door to thereby transmit a digital key to the vehicle 12. Then, in a case that authentication of the digital key is successful and a usage rule set for the digital key permits unlocking of the door, the door is unlocked.

For example, in a case that the mobile device 13 is brought close to the console in order to activate the vehicle 12, the NFC module 71 communicates with the console NFC reader 52 provided near the console to thereby transmit the digital key to the vehicle 12. Then, in a case that authentication of the digital key is successful, the vehicle 12 is activated, and also it becomes possible to use the vehicle 12 in accordance with set permitted usage, on the basis of the usage rule set for the digital key.

For example, the BLE module 72 communicates with the BLE module 53 of the vehicle 12 to thereby transmit the digital key to the vehicle 12. Then, in a case that authentication of the digital key is successful, it becomes possible to use the vehicle 12 in accordance with set permitted usage on the basis of the usage rule set for the digital key.

For example, the UWB module 73 communicates with the UWB module 54 of the vehicle 12 to thereby transmit the digital key to the vehicle 12. Then, in a case that authentication of the digital key is successful, it becomes possible to use the vehicle 12 in accordance with set permitted usage on the basis of the usage rule set for the digital key.

### <Configuration Example of Cloud System 11>

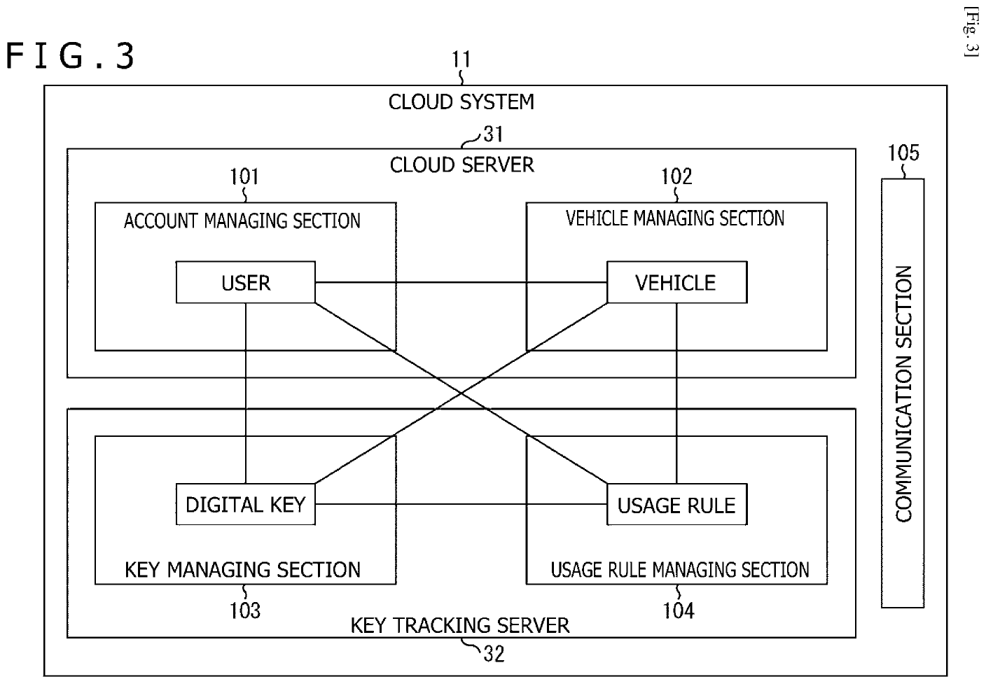

FIG. 3 depicts a configuration example of the cloud system 11 in FIG. 1.

The cloud system 11 includes an account managing section 101, a vehicle managing section 102, a key managing section 103, a usage rule managing section 104, and a communication section 105. For example, the account managing section 101 and the vehicle managing section 102 are realized by the cloud server 31. For example, the key managing section 103 and the usage rule managing section 104 are realized by the key tracking server 32. For example, the communication section 105 is realized by the cloud server 31 or another server.

The account managing section 101 manages an account of each user. For example, the account managing section 101 performs creation, updating and deletion of the account of each user, creation, updating, and deletion of user information included in each user account, and the like.

The vehicle managing section 102 manages information regarding each vehicle 12.

The key managing section 103 manages digital keys. For example, the key managing section 103 performs creation, retention, and deletion of digital keys, and pair keys that form pairs with the digital keys, and the like. For example, the key managing section 103 provides, to the mobile device 13, a Web site for performing creation, management, and the like of digital keys.

The usage rule managing section 104 manages usage rules. For example, the usage rule managing section 104 performs creation and changing of usage rules, creation, updating, and deletion of usage rule information representing the created or changed usage rules, and the like.

The account managing section 101, the vehicle managing section 102, the key managing section 103, and the usage rule managing section 104 manage a user account, a vehicle 12, a digital key, a pair key, and a usage rule in association with each other. This management may be executed in a coordinated manner by the account managing section 101, the vehicle managing section 102, the key managing section 103, and the usage rule managing section 104, or may be executed by some of them.

The communication section 105 communicates with vehicles 12, mobile devices 13, and FOBs 14. For example, the communication section 105 transmits a digital key and usage rule information to a mobile device 13. For example, the communication section 105 transmits a pair key, usage rule information, and the like to each vehicle 12. The communication section 105 may be one example of a transmitter and/or a receiver in this disclosure.

### <Configuration Example of Vehicle Control System 201>

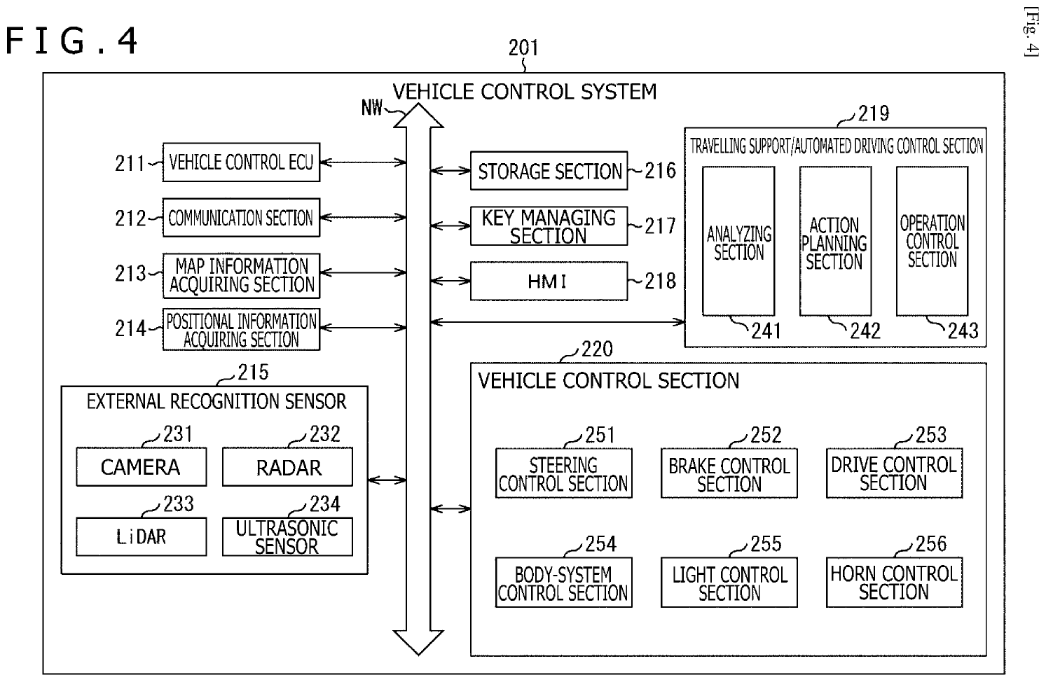

FIG. 4 is a block diagram depicting a configuration example of the vehicle control system 201 provided to the vehicle 12 in FIG. 1.

The vehicle control system 201 performs processes related to travelling support and automated driving of the vehicle 12.

The vehicle control system 201 includes a vehicle control ECU (Electronic Control Unit) 21, a communication section 212, a map information acquiring section 213, a positional information acquiring section 214, an external recognition sensor 215, a storage section 216, a key managing section 217, an HMI (Human Machine Interface) 218, a travelling support/automated driving control section 219, and a vehicle control section 220.

The vehicle control ECU 211, the communication section 212, the map information acquiring section 213, the positional information acquiring section 214, the external recognition sensor 215, the storage section 216, the travelling support/automated driving control section 219, the human machine interface (HMI) 218, and the vehicle control section 220 are connected mutually communicatively via a communication network NW. For example, the communication network NW includes a vehicle-mounted communication network, a bus, or the like conforming to a digital bidirectional communication standard such as CAN (Controller Area Network), LIN (Local Interconnect Network), LAN (Local Area Network), FlexRay (registered trademark), or Ethernet (registered trademark). Different networks may be used as the communication network NW on a case-by-case basis depending on the type of data to be transferred. For example, CAN may be applied to data related to vehicle control, and Ethernet may be applied to large-volume data. Note that, without using the com- munication network NW, for example, each section of the vehicle control system 201 is connected directly by using wireless communication targeted for communication over relatively short distances such as near field communication (NFC) or Bluetooth (registered trademark), in some cases.

Note that descriptions regarding the communication network NW are omitted below in a case that each section of the vehicle control system 201 performs communication via the communication network NW. For example, in a case that the vehicle control ECU 211 and the communication section 212 perform communication via the communication network NW, it is described simply that the vehicle control ECU 211 and the communication section 212 perform communication.

For example, the vehicle control ECU 211 includes various processors such as a CPU (Central Processing Unit) or an MPU (Micro Processing Unit). The vehicle control ECU 211 controls the functions of the whole or part of the vehicle control system 201.

The communication section 212 communicates with various pieces of equipment inside or outside the vehicle, other vehicles, servers, base stations or the like, and performs transmission/reception of various types of data. At this time, the communication section 212 can perform the communication by using a plurality of communication methods. For example, the communication section 212 includes the door NFC reader 51, the console NFC reader 52, the BLE module 53, and the UWB module 54 in FIG. 2. The communication section 212 may be one example of a transmitter and/or a receiver in this disclosure.

An overview of the communication that the communication section 212 can execute externally is explained. For example, the communication section 212 communicates with a server (hereinafter, called an external server) or the like that is on an external network via a base station or an access point by a wireless communication method such as 5G (5th Generation Mobile Communication System), LTE (Long Term Evolution), or DSRC (Dedicated Short Range Communications). For example, the external network that the communication section 212 uses for communication is the Internet, a cloud network, a network specific to a business operator, or the like. A communication method that the communication section 212 uses for the external network is not limited particularly as long as it is a wireless communication method that realizes a predetermined communication speed or higher and allows digital bidirectional communication over a predetermined distance or longer.

In addition, for example, the communication section 212 can communicate with a terminal that is present near the vehicle by using a P2P (Peer To Peer) technology. For example, the terminal that is present near the vehicle is a terminal attached to a pedestrian or a mobile body such as a bicycle that moves at relatively low speeds, a terminal that is fixedly installed at a store or the like, or an MTC (Machine Type Communication) terminal. Furthermore, the communication section 212 can also perform V2X communication. For example, V2X communication is communication between the vehicle and another thing such as vehicle to vehicle (Vehicle to Vehicle) communication with another vehicle, vehicle to infrastructure (Vehicle to Infrastructure) communication with roadside equipment or the like, communication with home (Vehicle to Home), or vehicle to pedestrian (Vehicle to Pedestrian) communication with a terminal carried by a pedestrian, or the like.

For example, the communication section 212 can receive, from the outside, a program for updating software that controls an operation of the vehicle control system 201 (Over The Air). The communication section 212 can further receive, from the outside, map information, traffic information, information regarding the environment around the vehicle 12, and the like. In addition, for example, the communication section 212 can transmit, to the outside, information regarding the vehicle 12, information regarding the environment around the vehicle 12, and the like. For example, examples of the information regarding the vehicle 12 that the communication section 212 transmits to the outside include data representing a state of the vehicle 12, results of recognition by an analyzing section 241, and the like. Furthermore, for example, the communication section 212 performs communication corresponding to a vehicle emergency report system such as eCall.

For example, the communication section 212 receives radio beacons, optical beacons or electromagnetic waves transmitted by a vehicle information and communication system (VICS (Vehicle Information and Communication System) (registered trademark)) such as FM multiplex broadcasting.

An overview of the communication that the communication section 212 can execute internally is explained. For example, the communication section 212 can communicate with each piece of equipment inside the vehicle by using wireless communication. For example, the communication section 212 can perform wireless communication with equipment inside the vehicle by a communication method such as wireless LAN, Bluetooth, NFC or WUSB (Wireless USB) that allows digital bidirectional communication by wireless communication at a predetermined communication speed or higher. The communication section 212 can also communicate with each piece of equipment inside the vehicle not only by using wireless communication, but by using wired communication. For example, the communication section 212 can communicate with each piece of equipment inside the vehicle by wired communication via a cable connected to an undepicted connection terminal. For example, the communication section 212 can communicate with each piece of equipment inside the vehicle by a communication method such as USB (Universal Serial Bus), HDMI (High-Definition Multimedia Interface) (registered trademark), or MHL (Mobile High-definition Link) that allows digital bidirectional communication by wired communication at a predetermined communication speed or higher.

Here, for example, equipment inside the vehicle means equipment that is located inside the vehicle and is not connected to the communication network NW. It is supposed that, for example, equipment inside the vehicle is mobile equipment or wearable equipment carried by a passenger such as a driver, information equipment carried to the inside of the vehicle and temporarily installed therein, and the like.

The map information acquiring section 213 accumulates maps provided from the outside and/or maps created at the vehicle 12. For example, the map information acquiring section 213 accumulates a three-dimensional high-precision map, a global map that has a precision lower than the high-precision map and covers a greater area, and the like.

For example, the high-precision map is a dynamic map, a point cloud map, a vector map, or the like. For example, the dynamic map is a map including four layers which arc dynamic information, semi-dynamic information, semi-static information, and static information, and is provided to the vehicle 12 from an external server or the like. The point cloud map is a map including a point cloud (point cloud data). For example, the vector map is a map in which traffic information such as the positions of lanes and traffic lights, and the like are associated with the point cloud map and are made conform to ADAS (Advanced Driver Assistance System) or AD (Autonomous Driving).

For example, the point cloud map and the vector map may be provided from an external server or the like, or may be created at the vehicle 12 as maps for performing matching with a local map mentioned later on the basis of results of sensing by a camera 231, a radar 232, a LiDAR 233, or the like, and may be accumulated in the map information acquiring section 213. In addition, in a case that the high-precision map is provided from an external server or the like, a map data of, for example, a several-hundred meter square about a planned path that the vehicle 12 is about to travel is acquired from an external server or the like in order to reduce the communication volume.

The positional information acquiring section 214 receives GNSS signals from a GNSS (Global Navigation Satellite System) satellite, and acquires positional information regarding the vehicle 12. The acquired positional information is supplied to the travelling support/automated driving control section 219. Note that the positional information acquiring section 214 may acquire positional information not only by using a method using GNSS signals, but by using beacons, for example.

The external recognition sensor 215 includes various sensors used for recognition of the situation outside the vehicle 12, and supplies sensor data from each sensor to each section of the vehicle control system 201. The types of sensor included in the external recognition sensor 215 and the number of the sensors are optional.

For example, the external recognition sensor 215 includes the camera 231, the radar 232, the LiDAR (Light Detection and Ranging, Laser Imaging Detection and Ranging) 233, and an ultrasonic sensor 234. The configuration of the external recognition sensor 215 is not limited to this, but the external recognition sensor 215 may include one or more types of sensor from among the camera 231, the radar 232, the LiDAR 233, and the ultrasonic sensor 234. The numbers of cameras 231, radars 232, LiDARs 233, and ultrasonic sensors 234 are not limited particularly as long as they can really be installed in or on the vehicle 12. In addition, the types of sensor included in the external recognition sensor 215 are not limited to those mentioned in this example, but the external recognition sensor 215 may include other types of sensor. An example of the sensing area of each sensor included in the external recognition sensor 215 is mentioned later.

Note that the image-capturing method of the camera 231 is not limited particularly. For example, cameras using various image-capturing methods such as a ToF (Time Of Flight) camera using an image-capturing method, a stereo camera, a monocular camera, or an infrared camera that can measure distances can be applied as the camera 231 as necessary. The camera 231 is not limited to these, but may be one that simply acquires captured images, irrespective of whether or not the camera 231 can measure distances.

In addition, for example, the external recognition sensor 215 can include an environment sensor for detecting the environment of the vehicle 12. The environment sensor is a sensor for detecting the environment related to weather, meteorology, brightness, or the like, and, for example, can include various sensors such as a raindrop sensor, a fog sensor, a sunshine sensor, a snow sensor, or an illuminance sensor.

Furthermore, for example, the external recognition sensor 215 includes a microphone used for detection of sounds around the vehicle 12 and positions of the sound sources, and the like.

The storage section 216 includes at least one of a non-volatile storage medium and a volatile storage medium and stores data and programs. For example, the storage section 216 is used as an EEPROM (Electrically Erasable Programmable Read Only Memory) and a RAM (Random Access Memory), and a magnetic storage device, a semiconductor storage device, an optical storage device, and a magneto-optical storage device such as an HDD (Hard Disc Drive) can be applied as storage media. The storage section 216 stores various programs and data used by each section of the vehicle control system 201. For example, the storage section 216 includes an EDR (Event Data Recorder) and a DSSAD (Data Storage System for Automated Driving), and stores information regarding the vehicle 12 before and after events such as accidents, and information acquired by various sensors for detecting information regarding the interior of the vehicle.

The storage section 216 stores a pair key and usage rule information received from the cloud system 11 in association with each other. Note that, in a case that pair keys and usage rule information corresponding to a plurality of digital keys are received from the cloud system 11, the storage section 216 stores pairs of a plurality of the pair keys and a plurality of pieces of the usage rule information, respectively.

The key managing section 217 performs management of digital keys and control of permitted usage of the vehicles 12 using the digital keys. For example, in a case that a digital key is received from the mobile device 13, the key managing section 217 acquires, from the storage section 216, a pair key that forms a pair with the received digital key, and executes an authentication process of the digital key. In a case that the authentication of the digital key is successful, the key managing section 217 acquires usage rule information associated with the pair key from the storage section 216, and controls permitted usage of the vehicle 12 on the basis of the usage rule information.

The HMI 218 is used for inputting various types of data, instruction, and the like, and presents various types of data to a driver and the like.

An overview of data input by using the HMI 218 is explained. The HMI 218 includes an input device for humans to input data. On the basis of data, an instruction, or the like input by using the input device, the HMI 218 creates an input signal and supplies the input signal to each section of the vehicle control system 201. For example, as the input device, the HMI 218 includes controllers such as a touch panel, buttons, switches, or levers. These are not the sole examples, but the HMI 218 may further include an input device that enables input of information by a non-manual-operation method using sounds, gestures, or the like. Furthermore, for example, the HMI 218 may use, as an input device, a remote control apparatus that uses infrared rays or radio waves, or externally connected equipment such as mobile equipment or wearable equipment that supports an operation of the vehicle control system 201.

An overview of data presentation by the HMI 218 is explained. The HMI 218 creates visual information, auditory information, and haptic information for passengers or the outside of the vehicle. In addition, the HMI 218 performs output control of controlling output of pieces of the created information, output content, output timings, output methods, and the like. For example, as visual information, the HMI 218 creates and outputs information represented by images or light of an operation screen, state display of the vehicle 12, warning display, a monitor image representing the situation around the vehicle 12, and the like. In addition, for example, as auditory information, the HMI 218 creates and outputs information represented by sounds such as sound guidance, warning sounds, or warning messages. Furthermore, for example, as haptic in- formation, the HMI 218 creates and outputs information to be given to the tactile sense of a passenger by forces, vibrations, motions, and the like.

As output devices that the HMI 218 uses to output visual information, for example, a display apparatus that presents visual information by using images displayed on itself, and a projector apparatus that presents visual information by projecting images can be applied. Note that, other than a display apparatus having a normal display, for example, the display apparatus may be an apparatus that displays visual information in the sight of a passenger such as a head-up display, a transmission display, or a wearable device having an AR (Augmented Reality) function. In addition, the HMI 218 can also use, as output devices that output visual information, display devices of a navigation apparatus, an instrument panel, a CMS (Camera Monitoring System), an electron mirror, lamps, and the like provided to the vehicle 12.

As output devices that the HMI 218 uses to output auditory information, for example, audio speakers, headphones, and earphones can be applied.

As output devices that the HMI 218 uses to output haptic information, for example, haptic elements using a haptics technology can be applied. For example, the haptic elements are provided to portions such as the steering wheel or a seat where a passenger of the vehicle 12 contacts.

The travelling support/automated driving control section 219 controls travelling support and automated driving of the vehicle 12. For example, the travelling support/automated driving control section 219 includes the analyzing section 241, an action planning section 242, and an operation control section 243.

The analyzing section 241 performs a process of analyzing the vehicle 12 and the situation around the vehicle 12.

For example, on the basis of sensor data from the external recognition sensor 215 and a high-precision map accumulated in the map information acquiring section 213, the analyzing section 241 estimates the current position of the vehicle 12. For example, on the basis of sensor data from the external recognition sensor 215, the analyzing section 241 creates a local map and performs matching between the local map and the high-precision map to thereby estimate the current position of the vehicle 12. For example, the position of the vehicle 12 is estimated by using, as its reference point, the axle of a rear-wheel pair.

For example, the local map is a three-dimensional high-precision map, an occupancy grid map (Occupancy Grid Map), or the like created by using a technology such as SLAM (Simultaneous Localization and Mapping). For example, the three-dimensional high-precision map is a point cloud map mentioned above, or the like. The occupancy grid map is a map on which a three-dimensional or two-dimensional space around the vehicle 12 is divided into grids (grids) with a predetermined size, and each grid represents an object occupancy state. For example, an object occupancy state is represented by whether or not there is an object or the probability of presence of an object. For example, the local map is used, by the analyzing section 241, also for processes of detecting and recognizing the situation outside the vehicle 12.

Note that the analyzing section 241 may estimate the current position of the vehicle 12 on the basis of positional information acquired by the positional information acquiring section 214, and sensor data from various sensors for detecting a state of the vehicle 12.

The analyzing section 241 performs a sensor fusion process of obtaining new information by combining a plurality of different types of sensor data (e.g., image data supplied from the camera 231, and sensor data supplied from the radar 232). Example of the method of combining different types of sensor data include integration, merging, concatenation, and the like.

The analyzing section 241 executes a detection process of detecting the situation outside the vehicle 12, and a recognition process of recognizing the situation outside the vehicle 12.

For example, on the basis of information from the external recognition sensor 215 or the like, the analyzing section 241 performs processes of detecting and recognizing the situation outside the vehicle 12.

Specifically, for example, the analyzing section 241 performs processes of detecting and recognizing objects around the vehicle 12, and the like. For example, the process of detecting objects is a process of detecting whether or not there is an object, and the size, shape, position, motions, and the like of an object. For example, the process of recognizing objects is a process of recognizing an attribute such as the type of an object, identifying a particular object, and so on. It should be noted that the detection process and the recognition process are not necessarily clearly separate processes, but overlap in some cases.

For example, the analyzing section 241 performs clustering of classifying point clouds based on sensor data from the radar 232, the LiDAR 233, or the like into clusters of point clouds, to thereby detect an object around the vehicle 12. Thereby, it is detected whether or not there is an object around the vehicle 12, and the size, shape, and position of an object.

For example, the analyzing section 241 performs tracking to track motions of clusters of point clouds classified by the clustering, to thereby detect motions of an object around the vehicle 12. Thereby, a speed and an advancing direction (motion vector) of an object around the vehicle 12 are detected.

For example, on the basis of image data supplied from the camera 231, the analyzing section 241 detects or recognizes vehicles, humans, bicycles, obstacles, structures, roads, traffic lights, traffic signs, road markings, and the like. In addition, the analyzing section 241 may recognize the type of an object around the vehicle 12 by performing a recognition process such as semantic segmentation.

For example, the analyzing section 241 can perform a process of recognizing traffic rules around the vehicle 12 on the basis of maps accumulated in the map information acquiring section 213, results of estimation of the current position, and results of recognition of objects around the vehicle 12. By this process, the analyzing section 241 can recognize the position and state of a traffic light, the content of a traffic sign and a road marking, the content of a traffic regulation, travelable lanes, and the like.

For example, the analyzing section 241 can perform a process of recognizing the environment around the vehicle 12. It is supposed that the environment around the vehicle 12 treated as recognition subjects by the analyzing section 241 includes weather, temperature, humidity, brightness, states of road surfaces, and the like.

The action planning section 242 creates an action plan of the vehicle 12. For example, the action planning section 242 creates an action plan by performing a process of path planning and path tracking.

Note that path planning (Global path planning) is a process of planning a general path from a start to a goal. This path planning includes a process, called trajectory planning, of performing creation (Local path planning) of a trajectory on a planned path and near the vehicle 12 that allows safe and smooth advancing, taking movement characteristics of the vehicle 12 into consideration.

Path tracking is a process of planning operation for safe and accurate travelling within a planned length of time for which a path has been planned by path planning. For example, on the basis of results of the process of path tracking, the action planning section 242 can compute a target speed and target angular speed of the vehicle 12.

The operation control section 243 controls operation of the vehicle 12 in order to realize an action plan created by the action planning section 242.

For example, the operation control section 243 controls a steering control section 251, a brake control section 252, and a drive control section 253 that are included in the vehicle control section 220 mentioned later, and performs acceleration/deceleration control and direction control such that the vehicle 12 advances along a trajectory computed by trajectory planning. For example, the operation control section 243 performs coordinated control aimed for realization of the ADAS function such as collision avoidance or shock mitigation, tracking travelling, travelling at a constant vehicle speed, collision warning about the vehicle, or lane deviation warning about the vehicle. For example, the operation control section 243 performs coordinated control aimed for automated driving of causing the vehicle 12 to autonomously travel or the like independently of an operation by a driver.

The vehicle control section 220 controls each section of the vehicle 12. The vehicle control section 220 includes the steering control section 251, the brake control section 252, the drive control section 253, a body-system control section 254, a light control section 255, and a horn control section 256.

The steering control section 251 performs detection, control, and the like of a state of a steering system of the vehicle 12. For example, the steering system includes a steering mechanism including a steering wheel and the like, an electrically-driven power steering, and the like. For example, the steering control section 251 includes a steering ECU that controls the steering system, an actuator that drives the steering system, and the like.

The brake control section 252 performs detection, control, and the like of a state of a brake system of the vehicle 12. For example, the brake system includes a brake mechanism including a brake pedal and the like, an ABS (Antilock Brake System), a regenerative brake mechanism, and the like. For example, the brake control section 252 includes a brake ECU that controls the brake system, an actuator that drives the brake system, and the like.

The drive control section 253 performs detection, control, and the like of a state of a drive system of the vehicle 12. For example, the drive system includes an accelerator pedal, a drive force generating apparatus such as an internal combustion engine or a drive motor for generating a drive force, a drive force transmission mechanism for transmitting the drive force to wheels, and the like. For example, the drive control section 253 includes a drive ECU that controls the drive system, an actuator that drives the drive system, and the like.

The body-system control section 254 performs detection, control, and the like of a state of a body system of the vehicle 12. For example, the body system includes a keyless entry system, a smart key system, power window apparatuses, power seats, an airconditioning apparatus, airbags, seat belts, a shift lever, and the like. For example, the body-system control section 254 includes a body system ECU that controls the body system, an actuator that drives the body system, and the like.

The light control section 255 performs detection, control, and the like of the states of various lights of the vehicle 12. For example, it is supposed that control-subject lights include headlights, backlights, fog lights, turn signals, brake lights, a projection, a bumper display, and the like. The light control section 255 includes a light ECU that controls lights, an actuator that drives lights, and the like.

The horn control section 256 performs detection, control, and the like of a state of a car horn of the vehicle 12. For example, the horn control section 256 includes a horn ECU that controls the car horn, an actuator that drives the car horn, and the like.

### <Configuration Example of Mobile Device 13>

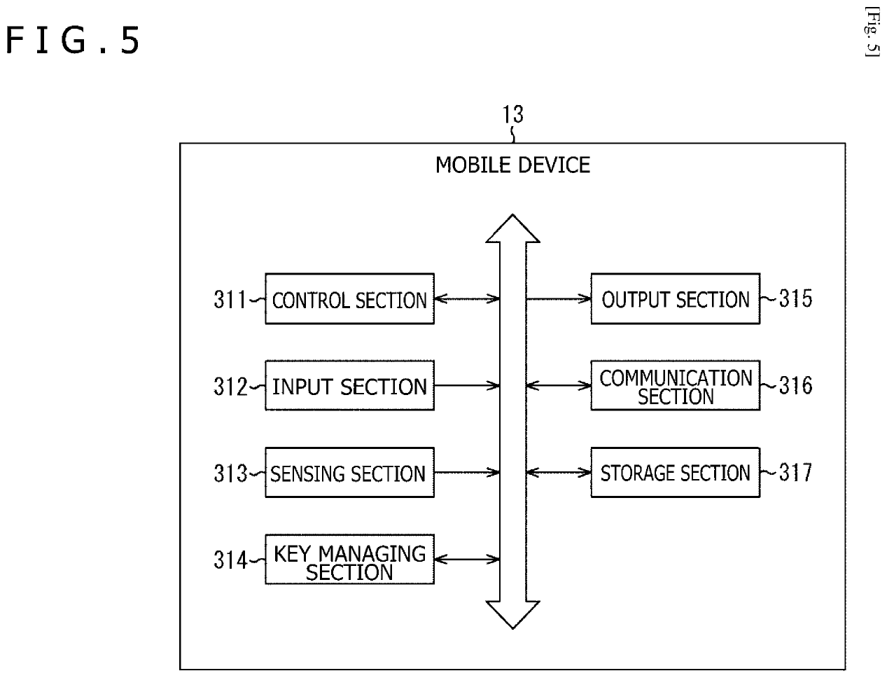

FIG. 5 depicts a configuration example of functions of the mobile device 13.

The mobile device 13 includes a control section 311, an input section 312, a sensing section 313, a key managing section 314, an output section 315, a communication section 316, and a storage section 317. The control section 311, the input section 312, the sensing section 313, the key managing section 314, the output section 315, the communication section 316, and the storage section 317 are connected with each other via a bus.

The control section 311 controls each section of the mobile device 13.

The input section 312 includes input devices for inputting various types of in- formation to the mobile device 13. For example, the input section 312 includes operation devices such as buttons, switches, or a touch panel.

The sensing section 313 includes various sensors. For example, the sensing section 313 includes a camera, an IMU (Inertial Measurement Unit), and the like. Each sensor of the sensing section 313 outputs sensor data representing results of sensing to the bus.

The key managing section 314 manages digital keys. For example, in accordance with a user operation and via the communication section 316, the key managing section 314 requests the cloud system 11 to create a digital key. For example, via the communication section 316, the key managing section 314 receives a digital key and usage rule information from the cloud system 11, and stores them on the storage section 317 in association with each other. For example, the key managing section 314 acquires the digital key from the storage section 317, and transmits the digital key to the vehicle 12 via the communication section 316.

The output section 315 includes output devices that output various types of information such as visual information, auditory information, or haptic information. For example, the output section 315 includes a display device that outputs visual information. For example, the output section 315 includes a sound output device that outputs auditory information. For example, the output section 315 includes a haptics device that outputs haptic information.

The communication section 316 includes the NFC module 71, the BLE module 72, the UWB module 73, and the like mentioned above with reference to FIG. 2, and communicates with the cloud system 11 and the vehicle 12. Note that the communication method of the communication section 316 is not limited particularly. In addition, the communication section 316 can adopt a plurality of communication methods. The communication section 316 may be one example of a transmitter and/or a receiver in this disclosure.

The storage section 317 stores various programs and data necessary for processes of the mobile device 13. For example, the storage section 317 stores a digital key and usage rule information received from the cloud system 11 in association with each other.

### <Example of Users of Information Processing System 1>

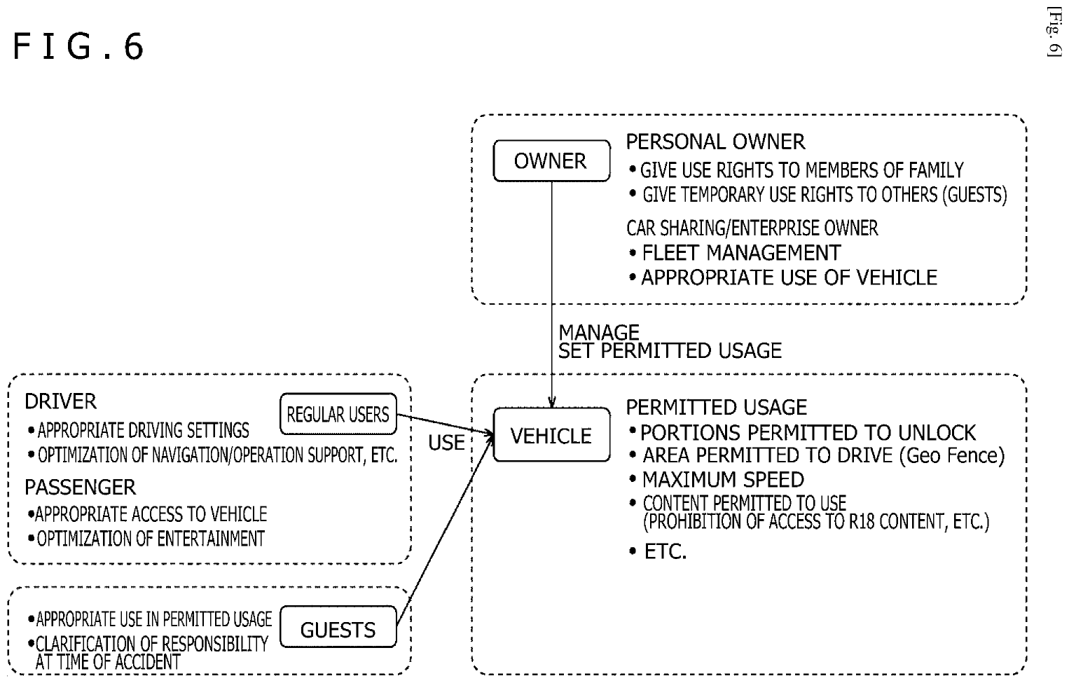

Next, an example of users of the information processing system 1 is explained with reference to FIG. 6.

Users of the information processing system 1 can be generally classified into an owner, regular users, and guests.

The owner is a natural person or a corporation who owns the vehicle 12.

For example, the owner includes a personal owner who owns the vehicle 12 personally. For example, by using the information processing system 1, the personal owner can give members of her/his family rights to use the vehicle 12, give others (guests) rights to use the vehicle 12 temporarily, and so on.

For example, the owner includes an enterprise that owns a company car, an owner of the enterprise, or the like. For example, the owner includes an enterprise that provides services for sharing the vehicle 12 as a rented car, a shared car or the like, an owner of the enterprise, or the like. For example, by using the information processing system 1, the enterprise or the enterprise owner can perform fleet management, allow each user to use the vehicle 12 appropriately, and so on.

In addition, for example, by using the information processing system 1, the owner manages the vehicle 12, sets permitted usage of the vehicle 12, and so on. For example, the permitted usage of the vehicle 12 relates to portions of the vehicle 12 that are permitted to unlock, an area that is permitted to drive (geo fence), a maximum speed, content that is permitted to use inside the vehicle, and the like.

For example, the regular users are users who use the vehicle 12 daily or regularly. For example, in a case that the owner is a natural person, the owner her/himself also can be a regular user. For example, the regular users include a driver and passengers.

For example, the driver is a user who drives the vehicle 12 daily or regularly. For example, it is supposed that the driver is the personal owner, members of her/his family, and the like.

For example, the information processing system 1 allows each driver to perform appropriate driving setting, optimize a navigation system, an operation support, and the like, and so on.

For example, the passengers are users who do not drive the vehicle 12, but get on it daily or regularly. For example, it is supposed that the passengers are the personal owner, members of her/his family, and the like.

For example, the information processing system 1 allows the passengers to access the vehicle 12 appropriately, optimize entertainment to enjoy in the vehicle 12, and so on.

For example, the guests are users who use the vehicle 12 temporarily. For example, it is supposed that the guests are friends of the personal owner, employees who use a company car, users who use a rented car or a shared car, and the like.

For example, the information processing system 1 allows the guests to use the vehicle 12 appropriately in accordance with permitted usage. In addition, for example, the information processing system 1 allows a guest to clarify where the responsibility lies and so on when an accident has occurred while the guest is using the vehicle 12.

Here, digital keys for using the vehicle 12 include at least two types including a master key and shared keys.

For example, the master key is a digital key used to use the vehicle 12 daily or regularly. For example, a regular user has the master key.

For example, the shared keys are digital keys used to use the vehicle 12 temporarily. For example, the guests have the shared keys.

<Relation among Accounts, Roles, and Usage Rules>

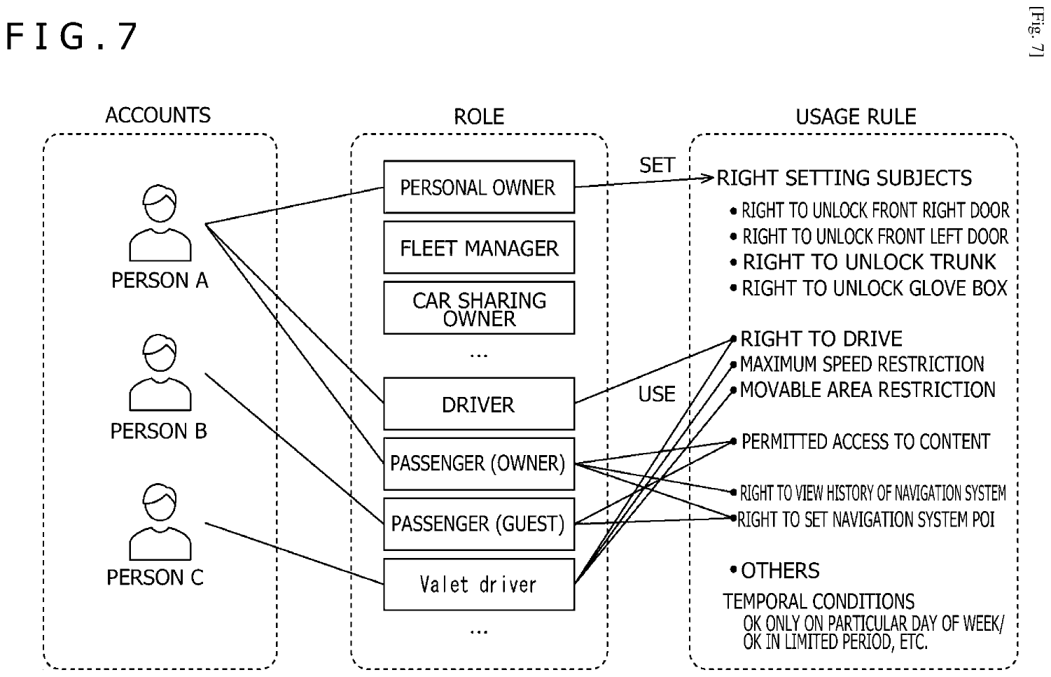

FIG. 7 depicts a relation among accounts, roles, and usage rules.

In the information processing system 1, each account is allocated with a role, and thereby a usage rule set for each role is applied to a corresponding account. That is, a usage rule is applied to each user having an account indirectly via a role. More specifically, a usage rule set for a role allocated to each user having an account is set for a digital key given to the user.

For example, it is supposed that a role allocated to the owner in FIG. 6 is a personal owner, a fleet manager, a car sharing owner or the like. These roles are owner-like roles, and a user allocated with an owner-like role (hereinafter, referred to as an owner-like user) is permitted to perform setting of usage rules itself.

For example, by giving a request to the cloud system 11 by using the mobile device 13, the owner-like user can set subjects for which rights to use the vehicle 12 are set. For example, it is supposed that setting-subject rights are a right to unlock the front right door of the vehicle 12, a right to unlock the front left door of the vehicle 12, a right to unlock the trunk of the vehicle 12, a right to unlock the glove box of the vehicle 12, and the like.

For example, by giving a request to the cloud system 11 by using the mobile device 13, the owner-like user can set the content of a usage rule set for each role. For example, when the content of a usage rule set for a role is changed, permitted usage of the vehicle 12 for a user allocated with the role is changed.

For example, it is supposed that roles allocated to regular users of FIG. 6 are a driver, a passenger (owner), and the like.

In this example, a usage rule including an unrestricted driving right is set for the driver.

In this example, a usage rule including permitted content access, a right to view the history of a navigation system, and a right to set POIs (Points of Interest) of the navigation system is set for the passenger (owner).

For example, it is supposed that roles allocated to the guests in FIG. 6 are a passenger (guest), a Valet driver, and the like.

In this example, a usage rule including permitted content access and a right to set POIs of the navigation system is set for the passenger (guest).

In this example, a usage rule including a restricted driving right, a maximum speed restriction, and a movable area restriction is set for the Valet driver.

Here, specific examples of usage rules are explained in more detail.

As mentioned above, usage rules are rules representing permitted usage of the vehicle 12. For example, a usage rule represents at least one of functional permitted usage of the vehicle 12, temporal permitted usage of the vehicle 12, and spatial permitted usage of the vehicle 12.

For example, the functional permitted usage of the vehicle 12 includes at least one of permitted usage regarding doors of the vehicle 12 that are permitted to lock and unlock, permitted usage of driving functions of the vehicle 12, permitted usage of functions of the HMI 218 of the vehicle 12, permitted usage regarding accessible content in the vehicle 12, permitted usage of maintenance functions of the vehicle 12, and an extent to which a driving situation of the vehicle 12 can be shared.

Specifically, for example, a usage rule sets permitted usage regarding doors of the vehicle 12 that are permitted to lock and unlock. For example, a usage rule permits locking and unlocking of only the door of the driver's seat, prohibits locking and unlocking of the doors of the rear seats and the trunk, and so on.

For example, a usage rule sets permitted usage of driving functions of the vehicle 12. For example, a usage rule disables driving functions, restricts the maximum speed of the vehicle 12, and so on.

For example, a usage rule sets permitted usage of functions of the HMI 218 of the vehicle 12. For example, a usage rule permits or restricts access to the history of a navigation system of the HMI 218, permits or restricts setting of POIs of the navigation system, and so on.

For example, a usage rule sets permitted usage regarding accessible content inside the vehicle. For example, a usage rule prohibits access to R18 content inside the vehicle.

For example, a usage rule sets permitted usage of maintenance functions of the vehicle 12. For example, a usage rule prohibits or restricts updating of software by OTA or usage of remote diagnostics.

For example, a usage rule sets the extent to which a driving situation of the vehicle 12 can be shared. For example, a usage rule permits driving in a stealth mode (privacy mode). The stealth mode is a mode to prevent logs related to driving from being uploaded to the cloud system 11 or the like.

For example, a usage rule sets a period, a time range, a day of the week, and the like in which the vehicle 12 can be used, as temporal permitted usage of the vehicle 12.

For example, a usage rule sets a geo fence as spatial permitted usage of the vehicle 12 and restricts the movable area of the vehicle 12 within the geo fence.

Note that permitted usage of the vehicle 12 represented by a usage rule may change corresponding to the situation around the vehicle 12. For example, functions of the vehicle 12 may be restricted on the basis of the number of pedestrians around the vehicle 12 recognized by the external recognition sensor 215. Specifically, for example, the maximum speed of the vehicle 12 may be restricted on the basis of the number of pedestrians recognized at an intersection or the like.

### <Processes of Information Processing System 1>

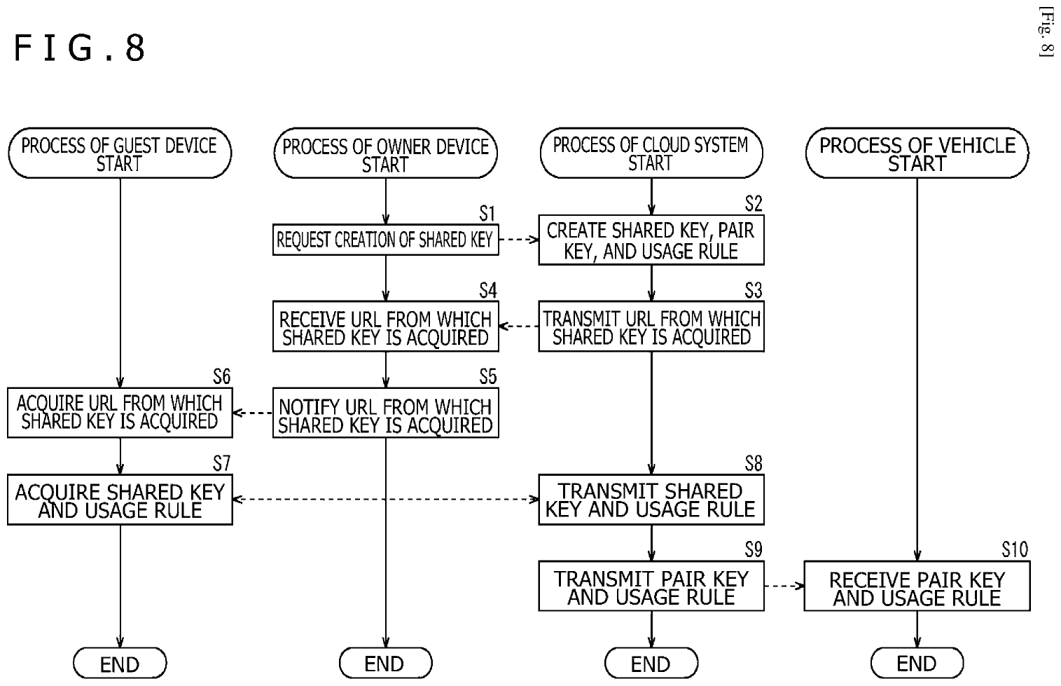

Next, processes of the information processing system 1 are explained with reference to FIG. 8 to FIG. 18.

### <Shared-Key Creation Process>

First, a shared-key creation process executed by the information processing system 1 is explained with reference to a flowchart in FIG. 8.

Note that, hereinbelow, a user of the owner device 13A is referred to as an owner, and a user of the guest device 13B is referred to as a guest.

At Step S1, the owner device 13A requests the cloud system 11 to create a shared key.

Specifically, under the control of the key managing section 314, the output section 315 of the owner device 13A displays a setting screen for requesting creation of a shared key.

In response to this, by performing a predetermined operation by using the input section 312, the owner requests creation of a shared key.

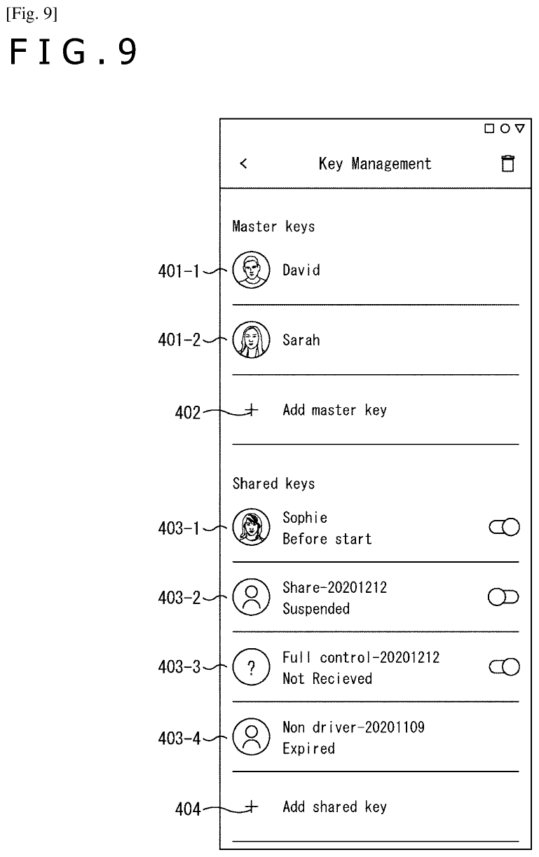

Here, a specific example of an operation for requesting creation of a shared key is explained with reference to FIG. 9 to FIG. 14.

FIG. 9 depicts an example of a digital-key list screen.

This screen displays a list of information related to users having digital keys (master keys and shared keys), and the like.

Specifically, this screen displays a master key field 401-1 and a master key field 401-2, a master-key addition button 402, a shared key field 403-1 to a shared key field 403-4, and a shared-key addition button 404.

The master key field 401-1 and the master key field 401-2 display information regarding corresponding master keys. Specifically, the master key field 401-1 and the master key field 401-2 display thumbnail images and names of corresponding users having master keys.

When the master-key addition button 402 is pressed, a screen for creating a new master key is displayed.

The shared key field 403-1 to the shared key field 403-4 display information regarding corresponding shared keys.

Specifically, the shared key field 403-1 displays a thumbnail image and user name of a user having a shared key, a state of the shared key, and a slider 403A-1. Here, the state of the shared key displaying “Before Start” represents that the usage of the shared key has not been started. When the slider 403A-1 is moved to the right, the shared key is enabled, and when the slider 403A-1 is moved to the left, the shared key is disabled.

The shared key field 403-2 displays a key mode, an expiration date/time (end date of the validity period), and a state of a shared key, and a slider 403A-2. Specifically, the depicted shared key field 403-2 represents that the key mode has been set to Share, and the expiration date/time has been set to Dec. 12, 2020, and the shared key has been temporarily disabled currently. Similarly, to the slider 403A-1, the slider 403A-2 is used to switch to enable or disable the shared key.

Note that, since there are no users having the corresponding shared key currently, the shared key field 403-2 does not display information regarding a user.

The shared key field 403-3 displays a key mode, an expiration date/time (end date of the validity period), and a state of a shared key, and a slider 403A-3. Specifically, the depicted shared key field 403-3 represents that the key mode has been set to Full Control, the expiration date/time has been set to Dec. 12, 2020, and the shared key has not been received by a user yet. Similarly, to the slider 403A-1, the slider 403A-3 is used to switch to enable or disable the shared key.

Note that, since there are no users having the corresponding shared key currently, the shared key field 403-3 does not display information regarding a user.

The shared key field 403-4 displays a key mode, an expiration date/time (end date of the validity period), and a state of a shared key. Specifically, the depicted shared key field 403-4 represents that the key mode has been set to Non Driver, the expiration date/time has been set to Nov. 9, 2020 and the expiration date/time has passed.

When the shared-key addition button 404 is pressed, a screen for creating a new shared key is displayed.

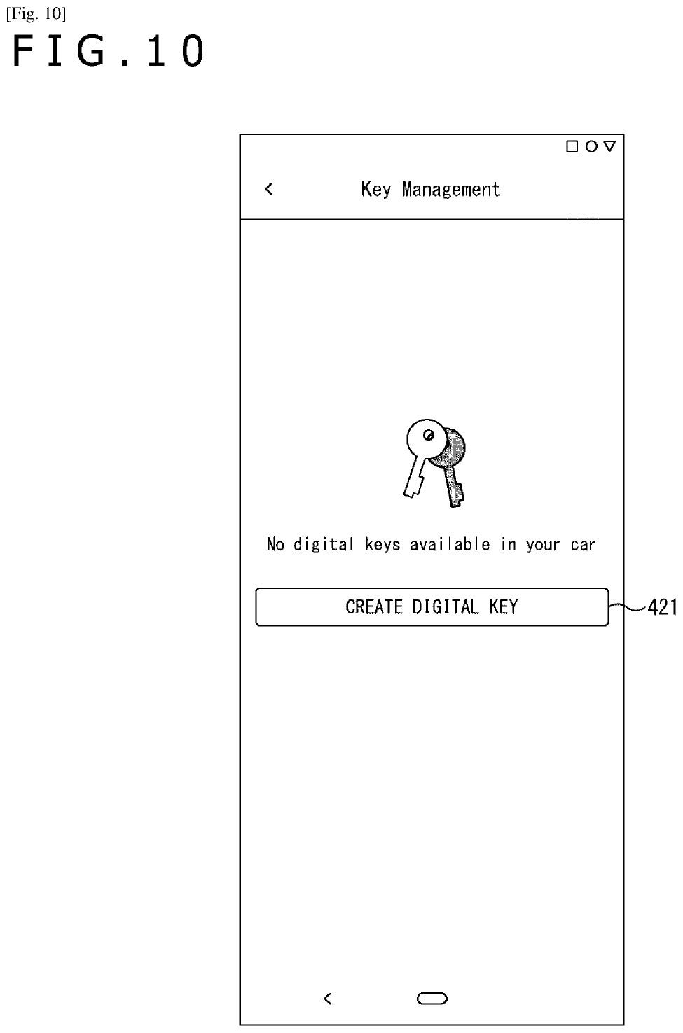

FIG. 10 depicts an example of a digital-key list screen in a case that there are no digital keys.

This screen displays information representing that there are no digital keys, and also a digital-key creation button 421.

When the digital-key creation button 421 is pressed, a screen for creating a new digital key is displayed.

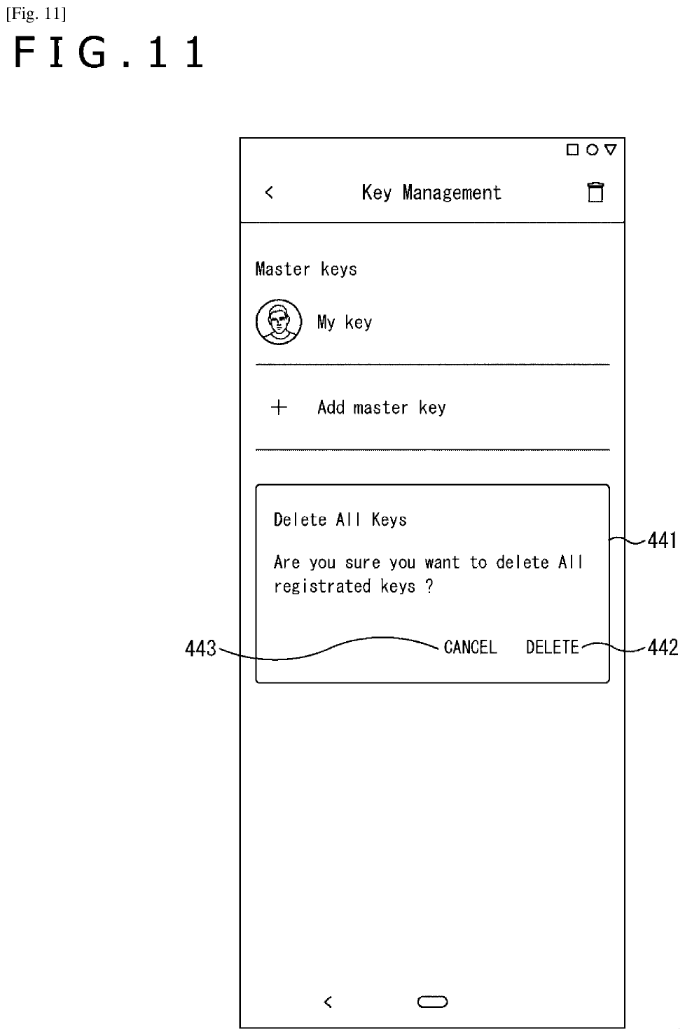

FIG. 11 depicts an example of a digital-key reset screen.

This screen displays a window 441 on the digital-key list screen.

The window 441 is provided to perform an operation of deleting all digital keys and displays a delete button 442 and a cancel button 443.

When the delete button 442 is pressed, all digital keys for a subject vehicle 12 are deleted.

When the cancel button 443 is pressed, an operation of deleting digital keys is cancelled.

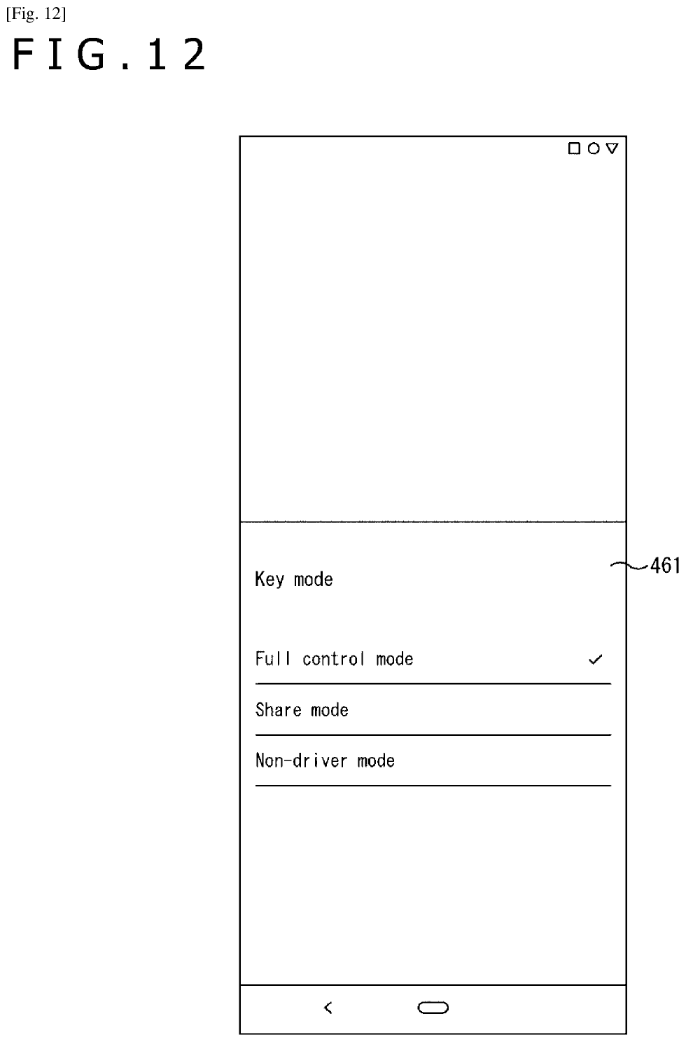

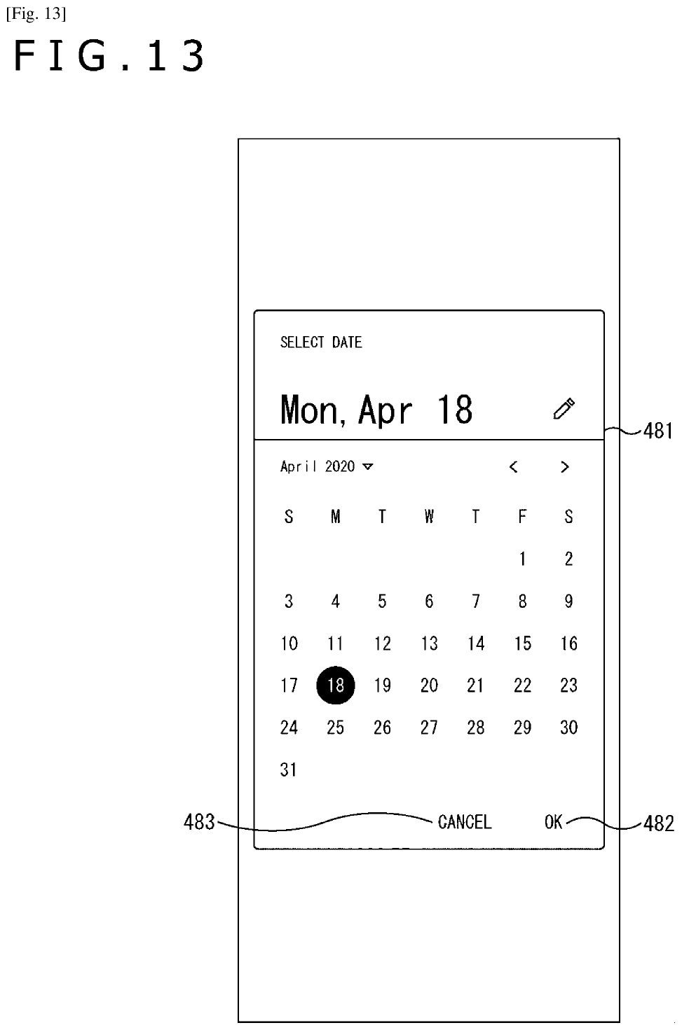

FIG. 12 and FIG. 13 depict examples of a shared-key creation screen.

FIG. 12 depicts an example of a key mode setting screen of the shared key.

This setting screen displays a key mode setting field 461. For example, in this example, a key mode can be selected from three types of a full control mode, a share mode, and a non-driver mode.

Here, a subject user to be given a shared key is a guest (FIG. 6). In this example, a role is set depending on a combination of the user type which is “guest,” and a key mode. Then, a usage rule set for the role is applied to the shared key (guest).

For example, in a case that a shared key for which the full control mode is set is used, it becomes possible to use the vehicle 12 without restrictions.

For example, in a case that a shared key for which the share mode is set is used, driving of the vehicle 12 is permitted, but permitted usage of the vehicle 12 is partially restricted.

For example, in a case that a shared key for which the non-driver mode is set is used, driving of the vehicle 12 is prohibited, and permitted usage of the vehicle 12 is partially restricted.

FIG. 13 depicts an example of a shared-key validity period setting screen.

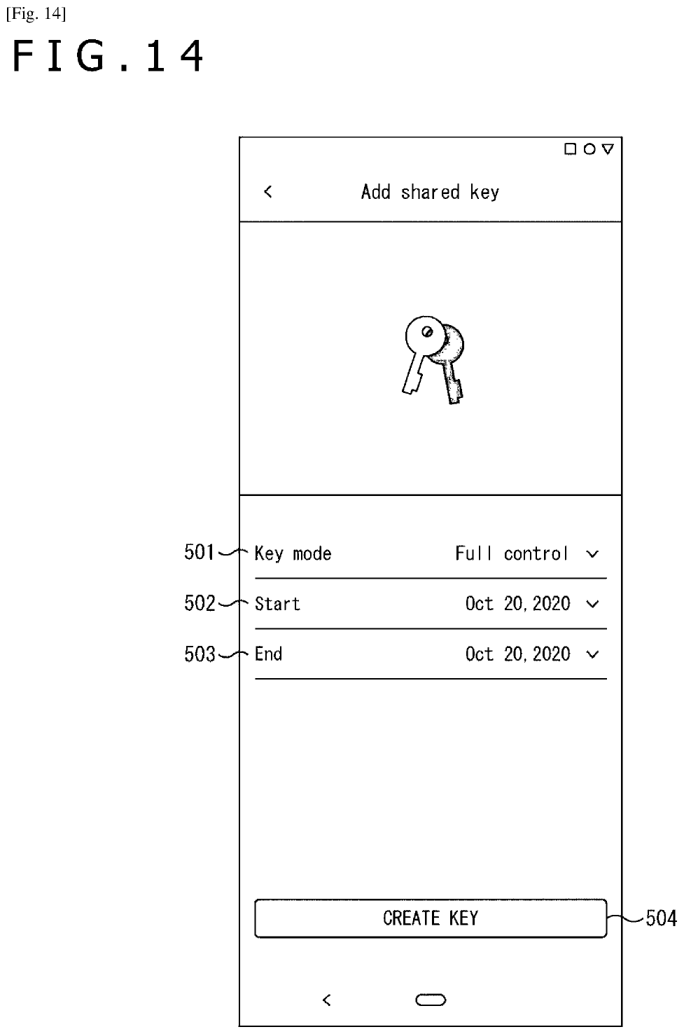

This screen displays a validity period setting field 481. For example, in this example, the validity period setting field 481 displays a calendar for setting the start date and end date of a validity period. In addition, an OK button 482 and a cancel button 483 are displayed. When the OK button 482 is pressed, the validity period is fixed, and, for example, a screen in FIG. 14 is displayed. When the cancel button 483 is pressed, setting of the validity period is cancelled, and, for example, the screen in FIG. 14 is displayed.

FIG. 14 depicts an example of the shared-key creation screen. This screen displays a key mode field 501, a start date field 502, an end date field 503, and a key creation button 504.

The key mode field 501 displays a key mode setting value. In addition, when the key mode field 501 is selected, for example, the setting screen in FIG. 12 is displayed.

The start date field 502 displays a start date setting value of the validity period of the shared key. In addition, when the start date field 502 is selected, for example, the setting screen in FIG. 13 is displayed.

The end date field 503 displays an end date setting value of the validity period of the shared key. In addition, when the end date field 503 is selected, for example, the setting screen in FIG. 13 is displayed.

When the key creation button 504 is pressed, the cloud system 11 is requested to create a shared key with the set key mode and validity period.

Specifically, the key managing section 314 creates shared-key creation request information requesting to create a shared key. For example, the shared-key creation request information includes account information regarding a user to use the shared key, identification information of a vehicle 12 to be used by using the shared key, the key mode, and the validity period. The key managing section 314 transmits the shared-key creation request information to the cloud system 11 via the communication section 316.

Returning to FIG. 8, at Step S2, the cloud system 11 creates a shared key, a pair key, and a usage rule.

Specifically, the communication section 105 receives the shared-key creation request information from the owner device 13A. On the basis of the shared-key creation request information, the key managing section 103 creates a shared key, and a pair key that forms a pair with the shared key. On the basis of the shared-key creation request information, the usage rule managing section 104 sets a usage rule for the shared key and the pair key and creates usage rule information representing the set usage rule. The account managing section 101, the vehicle managing section 102, the key managing section 103, and the usage rule managing section 104 store the created shared key, pair key and usage rule information, the user account, and the vehicle 12 in association with each other.

At Step S3, the cloud system 11 transmits a URL from which the shared key is acquired. Specifically, the key managing section 103 creates download information including a URL of a Web site from which the shared key is acquired. The key managing section 103 transmits the download information to the owner device 13A via the communication section 105.

At Step S4, the owner device 13A receives the URL from which the shared key is acquired. Specifically, the key managing section 314 of the owner device 13A receives the download information from the cloud system 11 via the communication section 316.

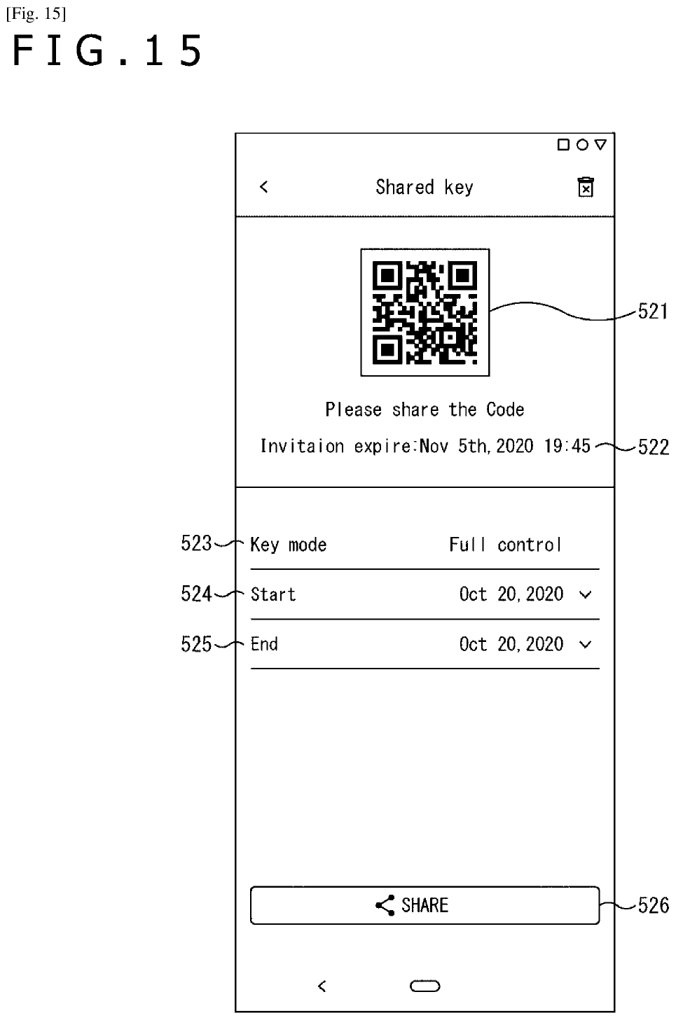

At Step S5, the owner device 13A notifies the URL from which the shared key is acquired. For example, in accordance with a user operation, under the control of the key managing section 314, the output section 315 displays a shared-key provision screen in FIG. 15.

The shared-key provision screen displays a QR code 521, an expiration date/time field 522, a key mode field 523, a start date field 524, an end date field 525, and a share button 526.

The QR code 521 represents the URL of the Web site from which the shared key is acquired. For example, the QR code 521 is created by the key managing section 314 converting the URL represented by the download information.

The expiration date/time field 522 displays an expiration date/time until which the shared key can be acquired from the Web site that can be accessed by using the URL represented by the QR code (registered trademark). For example, in this example, the expiration date/time field 522 displays 19:45 on Nov. 5, 2020 as the expiration date/time.

The key mode field 523 displays a key mode set for the shared key.

The start date field 524 displays the start date of the validity period of the shared key.

The end date field 525 represents the end date of the validity period of the shared key.

When the share button 526 is pressed, for example, the guest device 13B displays a screen for transmitting the URL from which the shared key is acquired.

At Step S6, the guest device 13B acquires the URL from which the shared key is acquired. For example, the guest captures an image of the QR code 521 on the shared-key provision screen in FIG. 15 by using a camera included in the sensing section 313 of the guest device 13B. The key managing section 314 of the guest device 13B converts the QR code 521 to the URL.

At Step S7, the guest device 13B acquires the shared key and the usage rule.

In response to this, at Step S8, the cloud system 11 transmits the shared key and the usage rule.

Specifically, for example, by using the input section 312 of the guest device 13B, the guest performs an operation of accessing the Web site represented by the URL acquired in the process at Step S6 and downloading the shared key.

In response to this, the key managing section 314 of the guest device 13B accesses the Web site represented by the acquired URL via the communication section 316.

In response to this, the communication section 105 of the cloud system 11 transmits the shared key and the usage rule information to the guest device 13B.

Then, the key managing section 314 of the guest device 13B downloads the shared key and the usage rule information from the cloud system 11 via the communication section 316. The key managing section 314 stores the acquired shared key and usage rule information on the storage section 317 in association with each other.

Thereby, it becomes possible to use the shared key on the guest device 13B.

At Step S9, the communication section 105 of the cloud system 11 transmits the pair key and the usage rule information to the vehicle 12.

In response to this, at Step S10, the key managing section 217 of the vehicle 12 receives the pair key and the usage rule information via the communication section 212. The key managing section 217 stores the received pair key and usage rule information on the storage section 216 in association with each other.

Thereby, the pair key and usage rule corresponding to the new shared key are registered in the vehicle 12.

Note that the process at Step S9 is executed at a time point when communication between the cloud system 11 and the vehicle 12 becomes possible after the process at Step S2. Accordingly, for example, the process at Step S9 may be executed before the process at Step S3 or before the process at Step S8.

As described above, the owner can create a shared key easily, and provide the shared key to a guest. In addition, the owner can set a usage rule for the shared key easily and set permitted usage of the vehicle 12 for the guest.

### <Process of Registering Unregistered Pair Key and Usage Rule>

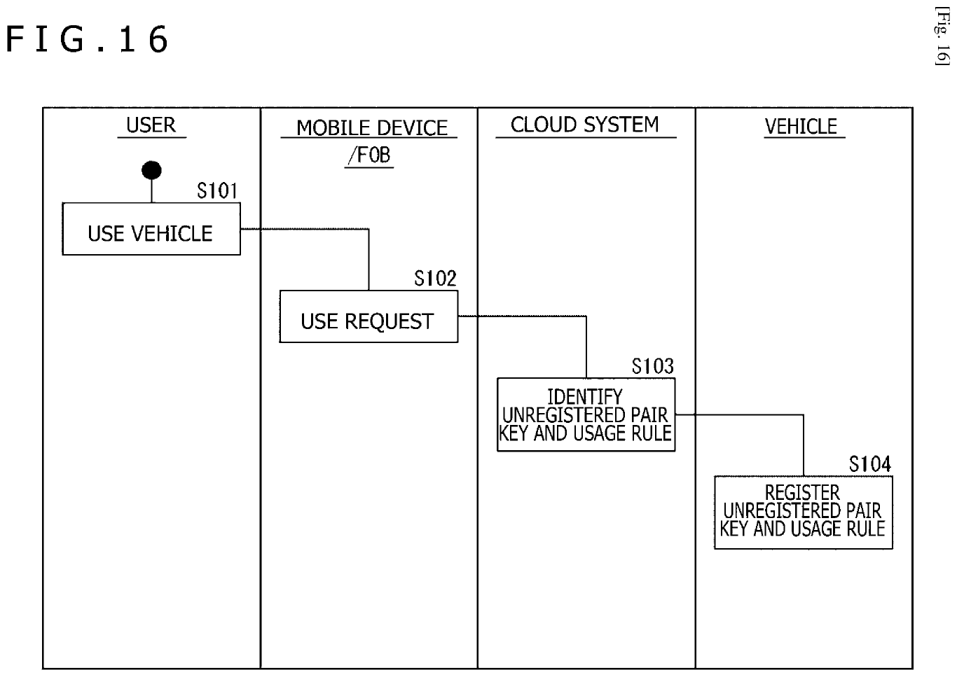

Next, a process of registering an unregistered pair key and usage rule in a vehicle 12 is explained with reference to a sequence diagram in FIG. 16.

In a case that, in the process mentioned above with reference to FIG. 8, the vehicle 12 is not activated when a shared key is created and the vehicle 12 cannot communicate with the cloud system 11, a pair key and a usage rule corresponding to the created shared key cannot be registered in the vehicle 12. To cope with this, this process is a process of registering an unregistered pair key and usage rule in the vehicle 12 when the vehicle 12 is activated and becomes possible for the vehicle 12 to perform communication.

At Step S101, a user performs an operation of using the vehicle 12 by using a mobile device 13 or an FOB 14 retaining a digital key (a master key or a shared key) for which a pair key and a usage rule are already registered in the vehicle 12. Here, for example, the operation of using the vehicle 12 is an operation of unlocking a door and activating the vehicle 12, or the like.

In response to this, the body-system control section 254 of the vehicle 12 unlocks the door and activates the vehicle 12.

At Step S102, the mobile device 13 or the FOB 14 transmits a use request to the cloud system 11. For example, the key managing section 314 of the mobile device 13 transmits the use request to the cloud system 11 via the communication section 316. Alternatively, for example, the FOB 14 transmits the use request to the cloud system 11.

At Step S103, the cloud system 11 identifies an unregistered pair key and usage rule. Specifically, the communication section 105 receives the use request transmitted from the mobile device 13 or the FOB 14. The key managing section 103 identifies a pair key and a usage rule that are unregistered in the vehicle 12 from among pair keys and usage rules corresponding to shared keys having been created.

At Step S104, the vehicle 12 registers the unregistered pair key and usage rule.

Specifically, the communication section 105 of the cloud system 11 transmits, to the vehicle 12, usage rule information corresponding to the pair key and the usage rule that have been identified at the process at Step S103.

In response to this, the key managing section 217 of the vehicle 12 receives the pair key and the usage rule information from the cloud system 11 via the communication section 212. The key managing section 217 stores the received pair key and usage rule information on the storage section 216 in association with each other.

Thereby, the unregistered and pair key and usage rule are automatically registered in the vehicle 12 at a time point when it becomes possible for the vehicle 12 to perform communication.

Note that, for example, when the vehicle 12 is activated, the key managing section 217 of the vehicle 12 may inquire the cloud system 11 of whether or not there are an unregistered pair key and usage rule. Then, in a case that there are an unregistered pair key and usage rule, the key managing section 217 of the vehicle 12 may receive the unregistered pair key and usage rule from the cloud system 11.

### <Process of Unlocking Door of Driver's Scat>

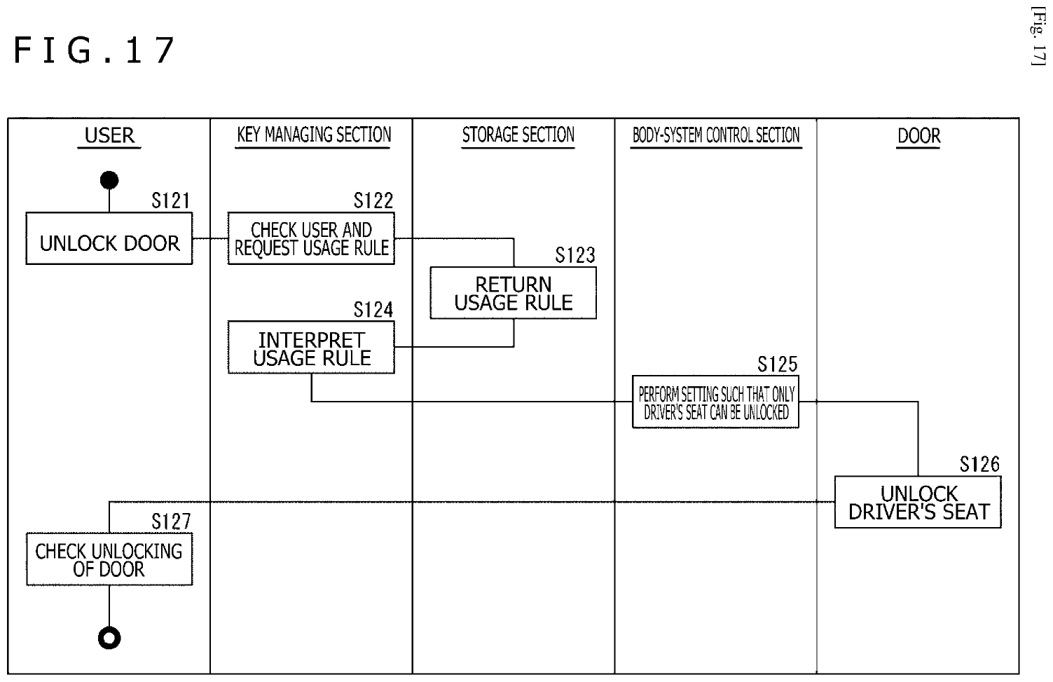

Next, a process in a case that the door of the driver's seat of the vehicle 12 is unlocked by using a shared key for which a usage rule that permits locking and unlocking of only the door of the driver's seat is set is explained with reference to a sequence diagram in FIG. 17.

At Step S121, a guest performs an operation of unlocking the door of the driver's scat by using the guest device 13B.

In response to this, the key managing section 314 of the guest device 13B transmits a shared key to the vehicle 12 via the communication section 316.

At Step S122, the key managing section 217 of the vehicle 12 checks the user (guest) and requests a usage rule. Specifically, the key managing section 217 receives the shared key from the guest device 13B via the communication section 212. The key managing section 217 searches the storage section 216 for a pair key that forms a pair with the shared key. In a case that a pair key that forms a pair with the shared key is found, the key managing section 217 performs a shared key authentication process by using the pair key to thereby check the user (guest). In a case that the shared key authentication is successful, the key managing section 217 requests usage rule information associated with the pair key from the storage section 216.

At Step S123, the storage section 216 returns the usage rule. Specifically, the storage section 216 supplies the usage rule information associated with the pair key to the key managing section 217.

At Step S124, the key managing section 217 of the vehicle 12 interprets the usage rule on the basis of the usage rule information. Thereby, the key managing section 217 recognizes that only the door of the driver's seat can be unlocked.

At Step S125, the vehicle 12 sets only the door of the driver's seat to an unlockable state. Specifically, the key managing section 217 instructs the body-system control section 254 to set only the door of the driver's seat to the unlockable state. In response to this, the body-system control section 254 sets only the door of the driver's seat to the unlockable state.

At Step S126, the body-system control section 254 of the vehicle 12 unlocks the door of the driver's seat.

At Step S127, the guest checks unlocking of the door of the driver's seat.

In this manner, the guest can unlock the door of the driver's seat easily by using the shared key.

### <Process of Unlocking Trunk>

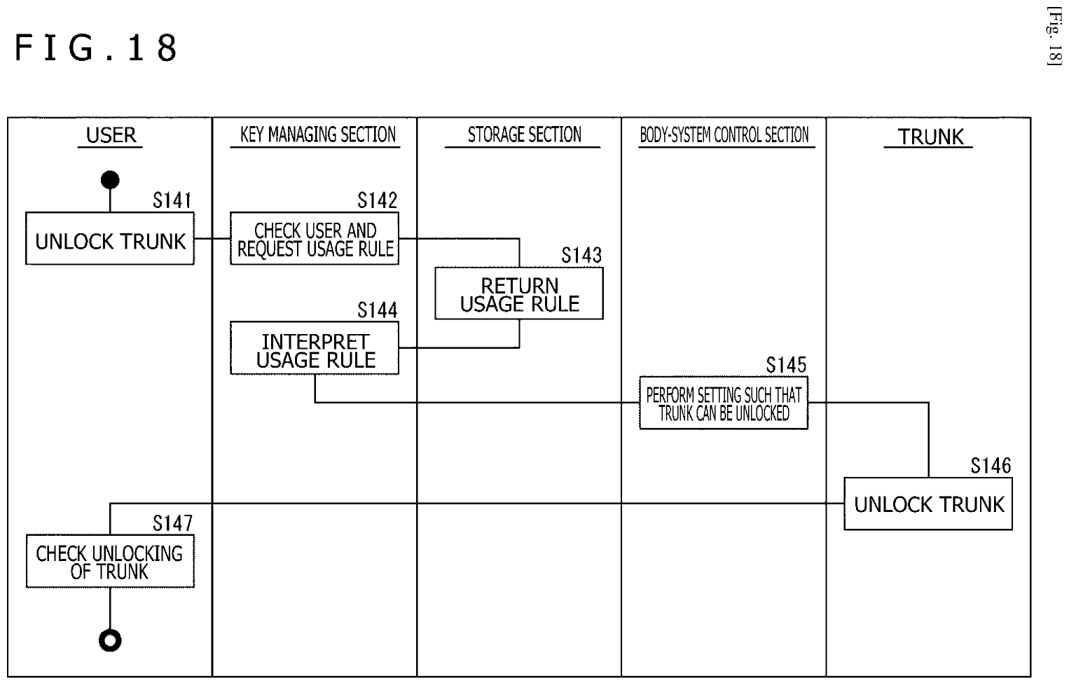

Next, a process in a case that the trunk of the vehicle 12 is unlocked by using a shared key for which a usage rule that permits locking and unlocking of the trunk is set is explained with reference to a sequence diagram in FIG. 18.

At Step S141, a guest performs an operation of unlocking the trunk by using the guest device 13B.

In response to this, the key managing section 314 of the guest device 13B transmits a shared key to the vehicle 12 via the communication section 316.

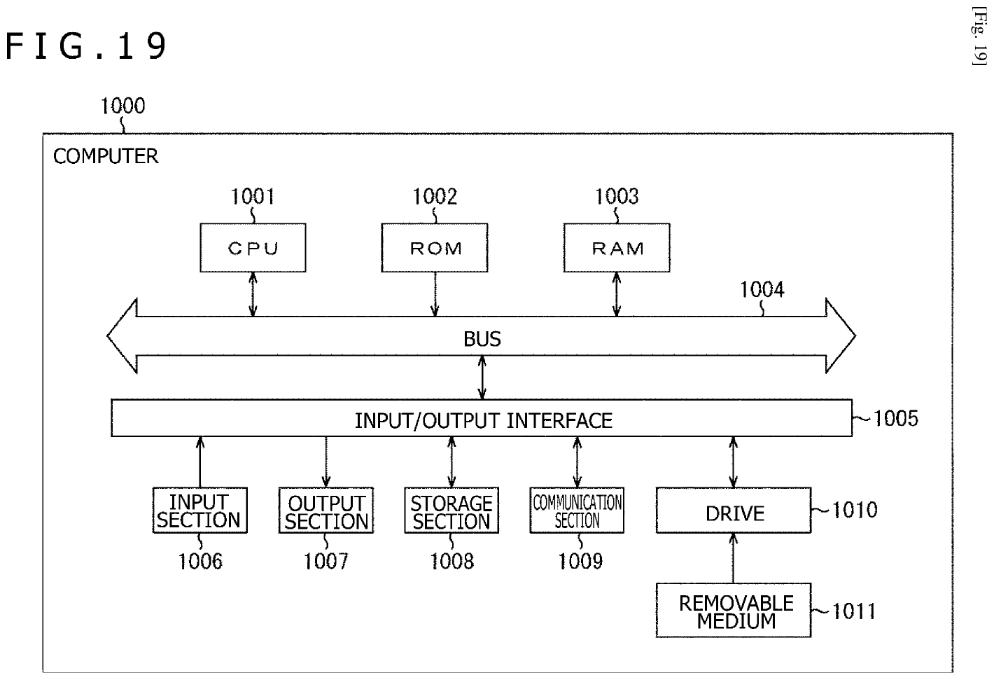

Similarly to the process at Step S122 in FIG. 19, at Step S142, the key managing section 217 of the vehicle 12 checks the user (guest) and requests a usage rule from the storage section 216.

Similarly to the process at Step S123 in FIG. 19, at Step S143, the usage rule is returned from the storage section 216 of the vehicle 12 to the key managing section 217.

At Step S144, the key managing section 217 of the vehicle 12 interprets the usage rule on the basis of the usage rule information. Thereby, the key managing section 217 recognizes that the trunk can be unlocked.

At Step S145, the vehicle 12 sets the trunk to an unlockable state. Specifically, the key managing section 217 instructs the body-system control section 254 to set the trunk to the unlockable state. In response to this, the body-system control section 254 sets the trunk to the unlockable state.

At Step S146, the body-system control section 254 of the vehicle 12 unlocks the trunk.

At Step S147, the user checks unlocking of the trunk.

In this manner, the guest can unlock the trunk easily by using the shared key.

Note that, in a case that the vehicle 12 is activated by using a digital key (a master key or a shared key), for example, a usage rule set for the digital key is enabled until the vehicle 12 is deactivated (the power supply is turned off). That is, after the activation of the vehicle 12, the digital key used for the activation of the vehicle 12 is enabled, and other digital keys cannot be used until the vehicle 12 is deactivated (the power supply is turned off).

### <Method of Setting Type and Content of Usage Rule>

Next, an example of a method of setting the type and content of a usage rule is explained.

Whereas the explanation above depicts examples in which the three types of usage rule are set for shared keys corresponding to the three types of key mode, for example, the information processing system 1 can increase or decrease the number of types of usage rule.

For example, by using the owner device 13A, an owner-like user requests the cloud system 11 to add or delete a type of usage rule. In response to this, in accordance with the request by the owner-like user, the usage rule managing section 104 of the cloud system 11 adds or delete the type of usage rule.

For example, the information processing system I can change the content of a usage rule, that is, permitted usage of the vehicle 12 represented by the usage rule, as appropriate.

For example, by using the owner device 13A, the owner-like user requests the cloud system 11 to change the content of the usage rule. In response to this, in accordance with the request by the owner-like user, the usage rule managing section 104 of the cloud system 11 changes the content of the usage rule.

For example, the information processing system 1 can change a subject item of the usage rule as appropriate. For example, the information processing system 1 can change a subject for which a right to use the vehicle 12 is set.

For example, by using the owner device 13A, the owner-like user requests the cloud system 11 to change (e.g., add or delete) a subject item of the usage rule. In response to this, in accordance with the request by the owner-like user, the usage rule managing section 104 of the cloud system 11 changes the subject item of the usage rule.

### <Method of Deleting Digital Key and Usage Rule>

Next, an example of a method of deleting a digital key and a usage rule is explained.

For example, a digital key and a usage rule information for which a usage period is set are deleted from the mobile device 13 automatically when the usage period has ended. Alternatively, for example, the digital key and the usage rule information may not be deleted, but simply disabled.

Similarly, for example, a pair key and usage rule information corresponding to a digital key for which a usage period is set are deleted from the vehicle 12 automatically when the usage period has ended. Alternatively, for example, the pair key and the usage rule information may not be deleted, but simply disabled.

For example, in a case that a shared key for which a usage period is not set is deleted or disabled, for example, by using the owner device 13A, the owner-like user requests the cloud system 11 to delete or disable the shared key.

In response to this, for example, in accordance with the request by the owner-like user, the usage rule managing section 104 of the cloud system 11 requests the guest device 13B to delete or disable the shared key and the usage rule via the communication section 105. In addition, in accordance with the request by the owner-like user, the usage rule managing section 104 of the cloud system 11 requests the vehicle 12 to delete or disable the pair key and the usage rule via the communication section 105

In response to this, the key managing section 314 of the guest device 13B deletes or disables the shared key and the usage rule information. The key managing section 217 of the vehicle 12 deletes or disables the pair key and the usage rule information.

As described above, easy and flexible setting of permitted usage of the vehicle 12 is enabled. That is, permitted usage of the vehicle 12 can be set for each user easily and specifically.

Thereby, for example, users who are permitted to drive the vehicle 12 can be managed easily. For example, a user who is permitted to perform valet parking, a user who is permitted to drive a company car, and the like can be managed easily.

### 2. Modification Examples

Modification examples of the embodiment of the present technology mentioned above are explained below.

<Modification Example Related to Usage Rules>

Whereas the explanation above depicts examples in which a usage rule is set in- directly via a role for each user (account), a usage rule may be set directly for each user.

For example, the key managing section 217 of the vehicle 12 may change the content of a usage rule in a case that an emergency such as an accident has occurred. For example, the key managing section 217 may change the content of a usage rule and increase the permitted usage of the vehicle 12 such that it becomes possible to cope with an emergency such as an accident promptly.

For example, a usage rule to be applied to a user may be set on the basis of the driving experience or driving skill of the user.

For example, a usage rule to be applied to a user may be set on the basis of the driving experience of the user known by an insurance company or the like. Specifically, for example, usage rules to be applied to the user may be set such that permitted usage of the vehicle 12 is increased as the driving experiences of users increase, permitted usage of the vehicle 12 is decreased as the driving experiences of users are insufficient.

For example, a usage rule to be applied to a user may be set on the basis of the remaining points of her/his driver's license. Specifically, for example, usage rules to be applied to users may be set such that permitted usage of the vehicle 12 is decreased as the remaining points of their driver's licenses decrease.

For example, a usage rule may be set for delivery companies. Specifically, for example, only a permission to unlock the trunk of the vehicle 12 may be set for delivery companies if the owner of the vehicle 12 asks the delivery companies to put packages in the trunk of the vehicle 12.

### <Modification Example Related to Exchange of Digital Key and Usage Rule>

For example, a digital key may be supplied from the cloud system 11 to the mobile device 13 via the vehicle 12. That is, a digital key may be transmitted from the cloud system 11 to the vehicle 12, and the digital key may be transmitted from the vehicle 12 to the mobile device 13.

For example, usage rule information may be supplied from the cloud system 11 to the vehicle 12 via the mobile device 13. That is, usage rule information may be transmitted from the cloud system 11 to the mobile device 13, and the usage rule information may be transmitted from the mobile device 13 to the vehicle 12.

For example, a pair key may be supplied from the cloud system 11 to the vehicle 12 via the mobile device 13. That is, a pair key may be transmitted from the cloud system 11 to the mobile device 13, and the pair key may be transmitted from the mobile device 13 to the vehicle 12.

Note that the mobile device 13 needs not to acquire usage rule information from the cloud system 11 necessarily.

In addition, for example, in a case that the vehicle 12 has retained in advance in- formation that enables authentication of digital keys, the vehicle 12 needs not to acquire pair keys from the cloud system 11 necessarily.

### <Other Modification Examples>

Note that, for example, in a case that a user uses the vehicle 12 by using a digital key, the vehicle 12 may perform user authentication as necessary in addition to authentication of the digital key. Then, in a case that the authentication of both the digital key and the user is successful, the authenticated user may be permitted to use the vehicle 12 in accordance with a usage rule.

For example, in a case that a plurality of guests uses shared keys to share the vehicle 12, it is possible to total mileage for each shared key. Regarding this, for example, in a case that the vehicle 12 is a company car, it is possible to execute settlement of expenses for the company for each user who is given a shared key. For example, in a case that the vehicle 12 is a vehicle for car sharing services, it is possible to charge a fee on the basis of the mileage of each user given a shared key.

### 3. Others

### <Configuration Example of Computer>

The series of processing mentioned above can be executed by hardware (i.e., circuitry that may be in the form of one or more circuits, including programmable circuits such as CPUs) and/or can also be executed by software that is executed on the circuitry so as to configure the circuitry to perform functions described herein. In a case that the series of processing is executed by software, a program included in the software is installed on a computer. Here, the computer may be a computer incorporated into dedicated hardware or, for example, a general-purpose personal computer or the like that can execute various functions by installing various programs.

FIG. 19 is a block diagram depicting a configuration example of hardware of a computer that executes the series of processing mentioned above by using a program.

In a computer 1000, a CPU (Central Processing Unit) 1001, a ROM (Read Only Memory) 1002, and a RAM (Random Access Memory) 1003 are interconnected by a bus 1004.

The bus 1004 is further connected with an input/output interface 1005. The input/output interface 1005 is connected with an input section 1006, an output section 1007, a storage section 1008, a communication section 1009, and a drive 1010.

The input section 1006 includes input switches, buttons, a microphone, an image-capturing element, and the like. The output section 1007 includes a display, speakers, and the like. The storage section 1008 includes a hard disk, a non-volatile memory and the like. The communication section 1009 includes a network interface and the like. The drive 1010 drives a removable medium 1011 such as a magnetic disc, an optical disc, a magneto-optical disc or a semiconductor memory.

In the thus-configured computer 1000, for example, the CPU 1001 loads a program recorded in the storage section 1008 to the RAM 1003 via the input/output interface 1005 and the bus 1004 and executes the program to thereby perform the series of processing mentioned above.

For example, the program executed by the computer 1000 (CPU 1001) can be provided by being recorded in the removable medium 1011 as a package medium or the like. In addition, the program can be provided via a cable or a wireless transfer medium such as a local area network, the Internet, or digital satellite broadcasting.

In the computer 1000, the program can be installed on the storage section 1008 via the input/output interface 1005 by attaching the removable medium 1011 to the drive 1010. In addition, the program can be received at the communication section 1009 via a cable or a wireless transfer medium and can be installed on the storage section 1008. Other than this, the program can also be installed in advance on the ROM 1002 or the storage section 1008.

Note that the program executed by the computer may be a program whose processes are performed in a temporal sequence along an order explained in the present specification or may be a program whose processes are performed in parallel or at necessary timings such as timings when those processes are called.

In addition, in the present specification, a system means a set of a plurality of constituent elements (apparatuses, modules (components), etc.), and it does not matter whether or not all the constituent elements are located in a single housing. Accordingly, a plurality of apparatuses housed in separate housings and connected via a network, and one apparatus with one housing having housed therein a plurality of modules are both systems.

Furthermore, embodiments of the present technology are not limited to the embodiment mentioned above, but can be changed in various manners within the scope not departing from the gist of the present technology.

For example, the present technology can adopt a configuration of cloud computing in which one function is shared among a plurality of apparatuses via a network and is processed in cooperation with each other.

In addition, other than being executed on one apparatus, each step explained in a flowchart mentioned above can be shared by a plurality of apparatuses and can be executed thereon.

Furthermore, in a case that one step includes a plurality of processes, other than being executed on one apparatus, the plurality of processes included in the one step can be shared among a plurality of apparatuses and can be executed thereon.

### <Configuration Combination Examples>

The present technology can also have a configuration as described below.

(1)

An information processing apparatus including:
a key managing section that creates a digital key for using a vehicle;
a usage rule managing section that sets a usage rule for the digital key, the usage rule representing permitted usage of the vehicle; and
a communication section that transmits the digital key to at least one of the vehicle and an information processing terminal that uses the digital key and transmits usage rule information representing the usage rule to at least one of the vehicle and the information processing terminal.
   (2)

The information processing apparatus according to (1), in which the usage rule managing section sets the usage rule for the digital key given to a first user, the usage rule being set for a role allocated to the first user.

(3)

The information processing apparatus according to (2), in which the usage rule managing section sets the usage rule to be associated with the role in accordance with a request from a second user allocated with the role which is an owner-like role.

(4)

The information processing apparatus according to any one of (1) to (3), in which the usage rule represents at least one of functional permitted usage of the vehicle, temporal permitted usage of the vehicle, and spatial permitted usage of the vehicle.

(5)

The information processing apparatus according to (4), in which the functional permitted usage of the vehicle includes at least one of: permitted usage regarding doors of the vehicle that are permitted to lock and unlock; permitted usage of driving functions of the vehicle; permitted usage of an HMI (Human Machine Interface) function of the vehicle; permitted usage regarding accessible content in the vehicle; permitted usage of a maintenance function of the vehicle; and an extent to which a driving situation of the vehicle is able to be shared.

(6)

The information processing apparatus according to (4) or (5), in which the temporal permitted usage of the vehicle includes a usage-permitted period of the vehicle.

(7)

The information processing apparatus according to any one of (4) to (6), in which the spatial permitted usage of the vehicle includes a movable area of the vehicle.

(8)

The information processing apparatus according to any one of (1) to (7), in which the usage rule managing section sets content of the usage rule in accordance with a request from a user.

(9)

The information processing apparatus according to any one of (1) to (8), in which the communication section transmits the digital key to the information processing terminal and transmits the usage rule information to the vehicle.

(10)

The information processing apparatus according to (9), in which the communication section further transmits the usage rule information to the information processing terminal.

(11)

The information processing apparatus according to (9) or (10), in which the key managing section creates a pair key including authentication information used for authentication of the digital key, and
the communication section transmits the pair key to the vehicle.
   (12)

An information processing method performed by an information processing apparatus, the information processing method including:
creating a digital key for using a vehicle;
setting a usage rule for the digital key, the usage rule representing permitted usage of the vehicle; and
transmitting the digital key to at least one of the vehicle and an information processing terminal that uses the digital key and transmitting usage rule information representing the usage rule to at least one of the vehicle and the information processing terminal.
   (13)

A vehicle control apparatus including:
a key managing section that controls permitted usage of a vehicle on a basis of a usage rule set for a digital key by an information processing apparatus that has created the digital key, the digital key being received from an information processing terminal.
   (14)

The vehicle control apparatus according to (13), in which the key managing section performs authentication of the digital key on a basis of a pair key that includes authentication information used for the authentication of the digital key, and is created by the information processing apparatus, and, in a case that the authentication of the digital key is successful, controls the permitted usage of the vehicle on a basis of the usage rule set for the digital key.

(15)

The vehicle control apparatus according to (13) or (14), in which the key managing section receives usage rule information representing the usage rule from the in- formation processing apparatus.

(16)

The vehicle control apparatus according to any one of (13) to (15), in which the usage rule represents at least one of functional permitted usage of the vehicle, temporal permitted usage of the vehicle, and spatial permitted usage of the vehicle.

(17)

The vehicle control apparatus according to (16), in which the functional permitted usage of the vehicle includes at least one of: permitted usage regarding doors of the vehicle that are permitted to lock and unlock; permitted usage of driving functions of the vehicle; permitted usage of an HMI function of the vehicle; permitted usage regarding accessible content in the vehicle; permitted usage of a maintenance function of the vehicle; and an extent to which a driving situation of the vehicle is able to be shared.

(18)

The vehicle control apparatus according to (16) or (17), in which the temporal permitted usage of the vehicle includes a usage-permitted period of the vehicle.

(19)

The vehicle control apparatus according to any one of (16) to (18), in which the spatial permitted usage of the vehicle includes a movable area of the vehicle.

(20)

An information processing terminal including:
a key managing section that acquires, from an information processing apparatus, a digital key for which a usage rule representing permitted usage of a vehicle is set; and
a communication section that transmits the digital key to the vehicle in a case that the vehicle is to be used.
   (21)

An information processing apparatus including:
circuitry configured to
create a digital key to operate a vehicle, and
set a usage rule for the digital key, the usage rule including usage rule information that sets permitted conditions of usage of the vehicle; and
a transmitter configured to
transmit the digital key to at least one of
the vehicle and/or an information processing terminal that uses the digital key, and transmit the usage rule information to at least one of
the vehicle and/or the information processing terminal.
   (22)

The information processing apparatus according to (21), wherein the circuitry sets the usage rule for the digital key according to a first user, the usage rule being set for a role allocated to the first user.

(23)

The information processing apparatus according to (22), wherein the circuitry sets the usage rule to be associated with the role allocated to the first user in accordance with a request message initiated by a second user who has been allocated an owner-like role.

(24)

The information processing apparatus according to any one of (21) to (23), wherein the usage rule for the digital key represents at least one of
functional permitted usage of the vehicle,
temporal permitted usage of the vehicle, and/or
spatial permitted usage of the vehicle.
   (25)

The information processing apparatus according to (24), wherein the functional permitted usage of the vehicle includes at least one of:
permitted usage regarding doors of the vehicle that are permitted to lock and unlock;
permitted usage of driving functions of the vehicle;
permitted usage of a HMI (Human Machine Interface) function of the vehicle;
permitted usage regarding accessible content in the vehicle;
permitted usage of a maintenance function of the vehicle; and/or
an extent to which a driving situation of the vehicle is sharable.
   (26)

The information processing apparatus according to (24) or (25), wherein the temporal permitted usage of the vehicle includes a usage-permitted period of time for the vehicle.

(27)

The information processing apparatus according to any one of (24) to (26), wherein the spatial permitted usage of the vehicle includes a movable area in which the vehicle is permitted to be located.

(28)

The information processing apparatus according to any one of (21) to (27), wherein the permitted usage of driving functions of the vehicle includes a maximum speed restriction of the vehicle.

(29)

The information processing apparatus according to any one of (21) to (28), wherein the circuitry is configured to set content of the usage rule in accordance with a user-initiated request.

(30)

The information processing apparatus according to any one of (21) to (29), wherein the transmitter is further configured to transmit the digital key to the information processing terminal and transmit the usage rule information to the vehicle.

(31)

The information processing apparatus according to (30), wherein the transmitter is configured to transmit the usage rule information to the information processing terminal.

(32)

The information processing apparatus according to (30) or (31), wherein the circuity is configured to create a key pair that includes authentication information to authenticate the digital key, and
the transmitter is configured to transmit the key pair to the vehicle.
   (33)

The information processing apparatus according to (23), wherein the circuitry is configured to set the usage rule based on a key mode identified in the request message, the key mode being selected from one of a full control mode, a share mode, and a non-driver mode.

(34)

The information processing apparatus according to (33), wherein, under a condition the full control mode is selected, the vehicle is operatable without restriction.

(35)

An information processing method performed by an information processing apparatus, the information processing method including:
creating a digital key to operate a vehicle;
setting a usage rule for the digital key, the usage rule including usage rule information that sets permitted conditions of usage of the vehicle;
transmitting the digital key to at least one of
the vehicle and/or an information processing terminal that uses the digital key; and
transmitting the usage rule information at least one of
the vehicle and/or the information processing terminal.
   (36)

A vehicle control apparatus including:
circuitry configured to
control permitted usage of a vehicle on a basis of a usage rule set for a digital key by an information processing apparatus that has created the digital key; and
a receiver configured to receive the digital key transmitted from an information processing terminal.
   (37)

The vehicle control apparatus according to (36), wherein the circuitry is configured to authenticate the digital key on a basis of a key pair that includes authentication information and is created by the information processing apparatus, and

under a condition the authentication of the digital key is successful, controls the permitted usage of the vehicle on a basis of the usage rule set for the digital key.
(38)

The vehicle control apparatus according to (36) or (37), wherein the receiver is configured to receive the usage rule information representing the usage rule from the information processing apparatus.

(39)

The information processing apparatus according to (37) or (38), wherein the receiver is configured to receive the digital key from the information processing apparatus via a Near Field Communication (NFC) transmission, a Bluetooth Low Energy (BLE) transmission, or an Ultra Wide Band (UWB) transmission.

(40)

An information processing terminal including:
a receiver configured to receive from an information processing apparatus a digital key for which a usage rule representing permitted usage of a vehicle is set;
circuitry configured to retain the digital key; and
a transmitter that transmits the digital key to the vehicle under a condition the information processing terminal has received an indication.

Note that advantages described in the present specification are illustrated merely as examples, but are not the sole examples, and there may be other advantages.

### REFERENCE SIGNS LIST

1: Information processing system
11: Cloud system
12: Vehicle
13: Mobile device
13A: Owner device
13B: Guest device
14: FOB
31: Cloud server
32: Key tracking server
101: Account managing section
102: Vehicle managing section
103: Key managing section
104: Usage rule managing section
105: Communication section
211: Vehicle control ECU
216: Storage section
217: Key managing section
218: HMI
220: Vehicle control section
254: Body-system control section
313: Sensing section
314: Key managing section
316: Communication section
317: Storage section

1. An information processing apparatus comprising:
circuitry configured to
create a digital key to operate a vehicle, and
set a usage rule for the digital key, the usage rule including usage rule information that sets permitted conditions of usage of the vehicle; and
a transmitter configured to
transmit the digital key to at least one of
the vehicle and/or an information processing terminal that uses the digital key, and
transmit the usage rule information to at least one of
the vehicle and/or the information processing terminal.

2. The information processing apparatus according to claim 1, wherein the circuitry sets the usage rule for the digital key according to a first user, the usage rule being set for a role allocated to the first user.

3. The information processing apparatus according to claim 2, wherein the circuitry sets the usage rule to be associated with the role allocated to the first user in accordance with a request message initiated by a second user who has been allocated an owner-like role.

4. The information processing apparatus according to claim 1, wherein the usage rule for the digital key represents at least one of
functional permitted usage of the vehicle,
temporal permitted usage of the vehicle, and/or
spatial permitted usage of the vehicle.

5. The information processing apparatus according to claim 4, wherein the functional permitted usage of the vehicle includes at least one of:
permitted usage regarding doors of the vehicle that are permitted to lock and unlock;
permitted usage of driving functions of the vehicle;
permitted usage of a HMI (Human Machine Interface) function of the vehicle;
permitted usage regarding accessible content in the vehicle;
permitted usage of a maintenance function of the vehicle; and/or
an extent to which a driving situation of the vehicle is sharable.

6. The information processing apparatus according to claim 4, wherein the temporal permitted usage of the vehicle includes a usage-permitted period of time for the vehicle.

7. The information processing apparatus according to claim 4, wherein the spatial permitted usage of the vehicle includes a movable area in which the vehicle is permitted to be located.

8. The information processing apparatus according to claim 1, wherein the permitted usage of driving functions of the vehicle includes a maximum speed restriction of the vehicle.

9. The information processing apparatus according to claim 1, wherein the circuitry is configured to set content of the usage rule in accordance with a user-initiated request.

10. The information processing apparatus according to claim 1, wherein the transmitter is further configured to transmit the digital key to the information processing terminal and transmit the usage rule information to the vehicle.

11. The information processing apparatus according to claim 10, wherein the transmitter is configured to transmit the usage rule information to the information processing terminal.

12. The information processing apparatus according to claim 10, wherein the circuity is configured to create a key pair that includes authentication information to authenticate the digital key, and the transmitter is configured to transmit the key pair to the vehicle.

13. The information processing apparatus according to claim 3, wherein the circuitry is configured to set the usage rule based on a key mode identified in the request message,
the key mode being selected from one of a full control mode, a share mode, and a non-driver mode.

14. The information processing apparatus according to claim 13, wherein, under a condition the the full control mode is selected, the vehicle is operatable without restriction.

15. An information processing method performed by an information processing apparatus, the information processing method comprising:
creating a digital key to operate a vehicle;
setting a usage rule for the digital key, the usage rule including usage rule information that sets permitted conditions of usage of the vehicle;
transmitting the digital key to at least one of
the vehicle and/or an information processing terminal that uses the digital key; and
transmitting the usage rule information at least one of
the vehicle and/or the information processing terminal.

16. A vehicle control apparatus comprising:
circuitry configured to control permitted usage of a vehicle on a basis of a usage rule set for a digital key by an information processing apparatus that has created the digital key; and
a receiver configured to receive the digital key transmitted from an information processing terminal.

17. The vehicle control apparatus according to claim 16, wherein
the circuitry is configured to
authenticate the digital key on a basis of a key pair that includes authentication information and is created by the information processing apparatus, and
under a condition the authentication of the digital key is successful, controls the permitted usage of the vehicle on a basis of the usage rule set for the digital key.

18. The vehicle control apparatus according to claim 16, wherein the receiver is configured to receive the usage rule information representing the usage rule from the information processing apparatus.

19. The information processing apparatus according to claim 17, wherein the receiver is configured to receive the digital key from the information processing apparatus via a Near Field Communication (NFC) transmission, a Bluetooth Low Energy (BLE) transmission, or an Ultra Wide Band (UWB) transmission.

20. An information processing terminal comprising:
a receiver configured to receive from an information processing apparatus a digital key for which a usage rule representing permitted usage of a vehicle is set;
circuitry configured to retain the digital key; and
a transmitter that transmits the digital key to the vehicle under a condition the information processing terminal has received an indication the vehicle is to be used.
